(19) United States
(12) Patent Application Publication
(10) Pub. No.: US 2017/0224000 A1
(43) Pub. Date: Aug. 10, 2017

(54) NUTRITIONAL POWDER PODS AND RELATED METHODS

(71) Applicant: ABBOTT LABORATORIES, Abbott Park, IL (US)

(72) Inventors: CYNTHIA BLACK, Westerville, OH (US); YOUNGSUK HEO, Powell, OH (US); TIMOTHY LAPLANTE, Powell, OH (US); PETER WESTFALL, Westerville, OH (US); GARY KATZ, Columbus, OH (US); CATHERINE LAMB, Westerville, OH (US); MARK ENGLE, Plain City, OH (US); NAGENDRA RANGAVAJLA, Dublin, OH (US)

(73) Assignee: ABBOTT LABORATORIES, Abbott Park, IL (US)

(21) Appl. No.: 15/327,950

(22) PCT Filed: Jul. 21, 2015
(86) PCT No.: PCT/US2015/041296

§ 371 Date: Jan. 20, 2017

Related U.S. Application Data
(60) Provisional application No. 62/026,885, filed on Jul. 21, 2014.

(51) Int. Cl. A23L 33/00; B65B 1/04; B65B 29/02; A47J 31/40; B65D 85/804

(52) U.S. Cl. CPC A23L 33/40; A47J 31/407; B65D 85/8043; B65B 29/02; B65B 1/04; A23V 2002/00

(57) ABSTRACT

Nutritional powders pods, generally in individual servings, suitable for use in beverage production machines are presented. The nutritional powder pods comprise pods containing a nutritional powder. The nutritional powder contained in the pods has specific characteristics, such as particle size, particle porosity, and powder density, which results in good reconstitution of the powder when it is reconstituted into a liquid product by a beverage production machine.

### CROSS-REFERENCE TO RELATED APPLICATIONS

This application claims priority to and any benefit of U.S. Provisional Application No. 62/026,885, filed Jul. 21, 2014, the content of which is incorporated herein by reference in its entirety.

### FIELD OF THE DISCLOSURE

The present disclosure relates to nutritional powder pods, generally in individual servings, suitable for use in beverage production machines.

### BACKGROUND

Beverage production machines that produce a single serving of a (typically hot or warm) beverage have become popular in recent years. These beverage production machines typically accept a container, also called a pod, designed for the particular model of machine, containing individual portions of a solid, concentrate, or other mixture intended to prepare the beverage of choice. The pods take various forms, such as pouches, cartridges, cups, and so forth.

Beverage production machines utilizing pods have many advantages. The user can easily select from a variety of beverage options, including diverse flavors of coffees, teas, hot cocoas, etc. With some machine designs, the user can customize the strength, intensity, temperature, or additives present in their beverage of choice, or create customized blends, such as dark roast coffee blended with hot cocoa, by using two or more beverage pods. The beverage production machine quickly produces a single serving of hot, fresh beverage on demand. The user does not have to wait, for example, for a full pot of fresh coffee to brew, or be content with a previously-prepared pot of coffee that is stale, cool, or scorched.

### SUMMARY

The present disclosure relates to nutritional powder pods suitable for use in beverage production machines. The nutritional powder in the pods has defined characteristics, which generally result in good reconstitution of the powder when it is reconstituted to a liquid product by a beverage production machine.

Some embodiments of the present disclosure are directed to a nutritional powder pod for use in a liquid product or beverage production machine. The nutritional powder pod comprises a pod containing a nutritional powder. The nutritional powder contained within the pod has a vibrated bulk density from about 0.2 g/cc to about 1 g/cc, and a powder porosity of from about 5% to about 80%.

Some embodiments of the present disclosure are directed to methods of making a nutritional powder pod for use in a liquid product or beverage production machine. The method comprises: producing a mixture comprising at least one nutritional ingredient; drying the mixture to form a nutritional powder; and packaging the nutritional powder into a pod. The nutritional powder has a vibrated bulk density from about 0.2 g/cc to about 1 g/cc, and a powder porosity of from about 5% to about 80%.

Some embodiments of the present disclosure are directed to a package containing a plurality of nutritional powder pods. The package contains nutritional powder pods comprising a nutritional powder with a vibrated bulk density from about 0.2 g/cc to about 1 g/cc, and a powder porosity of from about 5% to about 80%.

### BRIEF DESCRIPTION OF THE DRAWINGS

FIG. 1 illustrates the bottom and top sections of a bulk density test cylinder.

FIG. 2 illustrates a modified vibration tester used for the vibrated bulk density test method.

### DETAILED DESCRIPTION

While embodiments encompassing the general inventive concepts may take diverse forms, various embodiments will be described herein, with the understanding that the present disclosure is to be considered merely exemplary, and the general inventive concepts are not intended to be limited to the disclosed embodiments.

Some embodiments of the present disclosure are directed to a nutritional powder pod for use in a liquid product or beverage production machine. The nutritional powder pod comprises a pod containing a nutritional powder. The nutritional powder contained within the pod has a vibrated bulk density from about 0.2 g/cc to about 1 g/cc, and a powder porosity of from about 5% to about 80%.

Some embodiments of the present disclosure are directed to methods of making a nutritional powder pod for use in a liquid product or beverage production machine. The method comprises: producing a mixture comprising at least one nutritional ingredient; drying the mixture to form a nutritional powder; and packaging the nutritional powder into a pod. The nutritional powder has a vibrated bulk density from about 0.2 g/cc to about 1 g/cc, and a powder porosity of from about 5% to about 80%.

Some embodiments of the present disclosure are directed to a package containing a plurality of nutritional powder pods. The package contains nutritional powder pods comprising a nutritional powder with a vibrated bulk density from about 0.2 g/cc to about 1 g/cc, and a powder porosity of from about 5% to about 80%.

The terms “adult formula” and “adult nutritional product” as used herein are used interchangeably to refer to nutritional compositions suitable for generally maintaining or improving the health of an adult.

The term “agglomerated” as used herein, unless otherwise specified, refers to a nutritional powder that is processed such that individual powder particles are fused together to form porous aggregates of powder particles. The agglomerated nutritional powders described herein may be produced according to well known processes including, but not limited to, rewetting agglomeration, fluid-bed agglomeration, pressure agglomeration, and instantization by spray lecithination.

The term “apparent volume” as used herein, unless otherwise specified, refers to the volume of particles in a given portion of a nutritional powder, including closed pores, but excluding open pores and interstitial void volume.

The term “bulk density” as used herein, unless otherwise specified, refers to the density of powder or other finely-divided solid without excluding the open space. Bulk density is calculated by dividing the mass of a given portion of a powder by the total powder volume.

The term “closed pores” as used herein, unless otherwise specified, refers to pores in a particle that are isolated from the surface of the particle.

The term “envelope powder volume” as used herein, unless otherwise specified, refers to the volume of particles in a given portion of a nutritional powder, including all open pores, closed pores, and interstitial void volume. Typically, the term “envelope powder volume” implies that the powder has been compressed or otherwise treated to reduce the amount of interstitial void volume in the powder, as compared to the interstitial void volume present in a similar loose bulk powder.

The term “envelope volume” as used herein, unless otherwise specified, refers to the volume of particles in a given portion of a nutritional powder, including all open pores and closed pores, but excluding interstitial void volume.

The term “infant,” as used herein, unless otherwise specified, refers to a human about 36 months of age or younger. The term “toddler,” as used herein, unless otherwise specified, refers to a subgroup of infant that is about 12 months of age to about 36 months of age. The term “child,” as used herein, unless otherwise specified, refers to a human about 3 years of age to about 18 years of age. The term “adult, ” as used herein, unless otherwise specified, refers to a human about 18 years of age or older.

The terms “infant formula” or “infant nutritional product” as used herein are used interchangeably to refer to nutritional compositions that have the proper balance of macronutrients, micro-nutrients, and calories to provide sole or supplemental nourishment for and generally maintain or improve the health of infants, toddlers, or both. Infant formulas preferably comprise nutrients in accordance with the relevant infant formula guidelines for the targeted consumer or user population, an example of which would be the Infant Formula Act, 21 U.S.C. Section 350(a).

The term “initiation time” as used herein, unless otherwise specified, refers to the time at which any liquid from a beverage production machine first makes contact with or otherwise impinges upon the contents of a pod.

The term “interstitial void volume” as used herein, unless otherwise specified, refers to the open space between the tightly-packed particles in a given portion of a nutritional powder, excluding particle porosity.

The term “liquid product” as used herein, unless otherwise specified, refers to the reconstituted nutritional powder.

The term “loose bulk density” as used herein, unless otherwise specified, refers to the density (grams per unit volume) of nutritional powder that has not been tapped, packed, compressed, vibrated, or otherwise allowed to settle. It should be understood that for purposes of measuring loose bulk density on a given portion of a nutritional powder, a powder that has been tapped, packed, compressed, vibrated, or otherwise allowed to settle, can be re-distributed according to analytical methods such that loose bulk density can be measured.

The term “nutritional powder” as used herein, unless otherwise specified, refers to nutritional products that are solids or semisolids in the form of particles that are generally flowable or scoopable. A nutritional powder is usually reconstituted by addition of water or another liquid to form a liquid nutritional composition prior to administration to (e.g., providing to or consumption by) an individual. As discussed below, in certain embodiments disclosed herein, the nutritional powders comprise at least one of a source of protein, a source of carbohydrate, and a source of fat.

The term “nutritional powder pod” refers to a pod containing a certain volume or mass of a nutritional powder.

The term “open pores” as used herein, unless otherwise specified, refers to pores in a particle that have access to the surface of the particle.

The term “particle porosity” as used herein, unless otherwise specified, refers to the open pore volume (i.e., volume of open space contained within the powder particles) divided by the envelope volume.

The terms “particle” or “particles” as used herein, unless otherwise specified, refer to finely-divided pieces of solid material which make up a powder. It should be understood that “particles” includes both individual particles and agglomerated particles. When only individual particles are meant, the term “individual particle(s)” is used. When only agglomerated particles are meant, the term “agglomerated particle(s)” is used.

The terms “pediatric formula” or “pediatric nutritional product,” as used herein, are used interchangeably to refer to nutritional compositions suitable for generally maintaining or improving the health of toddlers, children, or both.

The term “pod” as used herein, unless otherwise specified, refers to a sealable, re-sealable or sealed container having an internal volume capable of containing a solid, powder, or liquid formulation that, when mixed with liquid, yields a liquid product suitable for human consumption.

The term “powder porosity” as used herein, unless otherwise specified, refers to open porous space contained within and open space between the powder particles. Powder porosity includes both interstitial void volume and open pore volume within the particles.

The term “powder void volume” as used herein, unless otherwise specified, refers to any open space contained between the particles of a nutritional powder. Typically, the term “powder void volume” implies that the powder is a loose bulk powder that may not have been tapped, packed, compressed, vibrated, or otherwise allowed to settle. Interstitial void volume is a sub-type of powder void volume, because “interstitial void volume” implies that the powder particles have been compressed or packed to some extent.

The terms “reconstitute,” “reconstituted,” and “reconstitution” as used herein, unless otherwise specified, are used to refer to a process by which the nutritional powder is mixed with a liquid, such as water, to form an essentially homogeneous liquid product. Once reconstituted in the liquid, the ingredients of the nutritional powder may be any combination of dissolved, dispersed, suspended, colloidally suspended, emulsified, or otherwise blended within the liquid matrix of the liquid product. Therefore, the resulting reconstituted liquid product may be characterized as any combination of a solution, a dispersion, a suspension, a colloidal suspension, an emulsion, or a homogeneous blend.

The term “serving” as used herein, unless otherwise specified, is any amount of a composition that is intended to be ingested by a subject in one sitting or within less than about one hour. The size of a serving (i.e., “serving size”) may be different for diverse individuals, depending on one or more factors including, but not limited to, age, body mass, gender, species, or health. For a typical human child or adult, a serving size of the compositions disclosed herein is from about 25 mL to 1,000 mL. For a typical human infant or toddler, a serving size of the compositions disclosed herein is from about 5 mL to about 250 mL.

The term “total powder volume” as used herein, unless otherwise specified, refers to the volume occupied by a given portion of a nutritional powder, including the envelope volume plus the powder void volume. Typically, the term “total powder volume” implies that the powder is a loose bulk powder that has not been tapped, packed, compressed, vibrated, or otherwise allowed to settle.

The term “total void volume” as used herein, unless otherwise specified, refers to any open space contained within the volume of a given portion of a nutritional powder that is not part of the solid powder material. The total void volume may comprise, for example, interstitial void volume or powder void volume between the powder particles, plus the open pore and closed pore volume within each powder particle.

The term “true density” as used herein, unless otherwise specified, refers to the mass of a given portion of a nutritional powder divided by the true volume.

The term “true volume” as used herein, unless otherwise specified, refers to the volume of solid material in the particles, excluding the total void volume (i.e., closed pores, open pores, and space between particles).

The term “vibrated bulk density” as used herein, unless otherwise specified, refers to the density (grams per unit volume) of powder that has been compressed using the Vibrated Bulk Density Test method, described below.

### Nutritional Powder Pods

As discussed above, the present disclosure relates to nutritional powder pods suitable for use in beverage production machines. The pod body is molded or otherwise constructed of a food-safe material, e.g., a plastic such as polypropylene or polyethylene, a metal or metal foil such as steel or aluminum, a natural product such as paper or other fiber based material, and combinations thereof. In some embodiments, the pod may be configured to receive an injector or similar device through which water, air, or other fluids may be introduced to facilitate mixing and reconstitution within the enclosed volume. In some embodiments, the fluid introduced to the pod may be pre-filtered, or alternatively the fluid may pass through a filtration unit disposed within the pod. In some embodiments, an outlet member integrally formed as part of or movably coupled to the pod may be positioned for dispensing from the pod.

In certain embodiments, the contents of the pod (i.e., the nutritional powder) are intended to be processed (i.e., reconstituted into a liquid product suitable for oral consumption by an individual) within seconds after the hermetic seal of the pod is broken to allow liquid to flow therein, the contents to flow therefrom, or a combination thereof. In such embodiments, the pod will typically be a single-use, disposable container. In other embodiments, the pod is sealable or re-sealable and is capable of re-use. In certain embodiments where the pod is sealable or re-sealable, the contents of the pod (i.e., the nutritional powder) may be stored for a short time (typically hours or days) by the consumer prior to reconstituting into a liquid product, and the pod may or may not be hermetically sealed at any point.

In certain embodiments, any delay between the time the hermetic seal of the pod is disrupted and the initiation time is less than 1 second. In other embodiments, any delay between the time the hermetic seal of the pod is disrupted and the initiation time is less than 2 seconds. In other embodiments, any delay between the time the hermetic seal of the pod is disrupted and the initiation time is less than 3 seconds. In other embodiments, any delay between the time the hermetic seal of the pod is disrupted and the initiation time is less than 4 seconds. In other embodiments, any delay between the time the hermetic seal of the pod is disrupted and the initiation time is less than 5 seconds. In other embodiments, any delay between the time the hermetic seal of the pod is disrupted and the initiation time is within the range of 1 second to 10 seconds. In some embodiments, a delay between the time the hermetic seal of the pod is disrupted and the initiation time is within the range of 1 second to 30 seconds.

In certain embodiments, the pod contains an amount of nutritional powder corresponding to a single serving. The amount of nutritional powder corresponding to a single serving may vary, for example, based on the intended consumer (e.g., an infant, a toddler, a child, an adult, a healthy individual, a sick individual). In some instances, more nutritional powder than is needed for a single serving may be included in the pod, such as when an ingredient of the formulation is likely to degrade or otherwise lose effectiveness over time.

In certain embodiments, the pod encloses an amount of a nutritional powder that is suitable for being reconstituted into a single serving of a liquid product upon combination with a certain volume of liquid. In certain embodiments, the pod contains about 2 grams to about 150 grams of nutritional powder, including about 2 grams to about 100 grams, including about 2 grams to about 80 grams, including about 2 grams to about 60 grams, including about 2 grams to about 50 grams, including about 2 grams to about 35 grams, including about 2 grams to about 30 grams, including about 2 grams to about 25 grams, including about 2 grams to about 20 grams, including about 2 grams to about 15 grams, including about 2 grams to about 10 grams, including about 5 grams to about 150 grams, including about 5 grams to about 100 grams, including about 5 grams to about 80 grams, including about 5 grams to about 60 grams, including about 5 grams to about 50 grams, including about 5 grams to about 35 grams, including about 5 grams to about 30 grams, including about 5 grams to about 25 grams, including about 5 grams to about 20 grams, including about 5 grams to about 15 grams, including about 10 grams to about 150 grams, including about 10 grams to about 100 grams, including about 10 grams to about 80 grams, including about 10 grams to about 60 grams, including about 10 grams to about 50 grams, including about 10 grams to about 40 grams, including about 10 grams to about 35 grams, including about 10 grams to about 30 grams, including about 10 grams to about 25 grams, including about 10 grams to about 20 grams, including about 15 grams to about 150 grams, including about 15 grams to about 100 grams, including about 15 grams to about 80 grams, including about 15 grams to about 60 grams, including about 15 grams to about 50 grams, including about 15 grams to about 40 grams, including about 15 grams to about 35 grams, including about 15 grams to about 30 grams, including about 15 grams to about 25 grams, including about 20 grams to about 150 grams, including about 20 grams to about 100 grams, including about 20 grams to about 80 grams, including about 20 grams to about 60 grams, including about 20 grams to about 50 grams, including about 20 grams to about 40 grams, including about 20 grams to about 35 grams, including about 20 grams to about 30 grams, including about 25 grams to about 150 grams, including about 25 grams to about 100 grams, including about 25 grams to about 80 grams, including about 25 grams to about 60 grams, including about 25 grams to about 50 grams, including about 25 grams to about 40 grams, including about 25 grams to about 35 grams, including about 30 grams to about 150 grams, including about 30 grams to about 100 grams, including about 30 grams to about 80 grams, including about 30 grams to about 60 grams, including about 30 grams to about 50 grams, including about 30 grams to about 40 grams, including about 40 grams to about 150 grams, including about 40 grams to about 100 grams, including about 40 grams to 80 grams, including about 40 grams to 60 grams, including about 40 grams to 50 grams, including about 50 grams to about 150 grams, and including about 50 grams to 100 grams of nutritional powder. In certain embodiments, the pods contain about 8 grams, about 10 grams, about 12 grams, about 15 grams, about 20 grams, about 25 grams, about 30 grams, about 35 grams, about 40 grams, about 50 grams, about 60 grams, about 80 grams, about 90 grams, about 100 grams, about 125 grams, or about 150 grams of nutritional powder.

Non-limiting examples of ways in which the present nutritional powder pods may be utilized include their use in a beverage production machine to produce the following liquid products: a hot beverage (e.g., coffee, tea, or cocoa); a tepid or cool beverage (e.g., an infant formula, a malted beverage, a fruit or juice beverage, a carbonated beverage, a soft drink, or a milk based beverage); a performance beverage (e.g., a performance ready-to-drink beverage); or a functional beverage (e.g., a slimming beverage, a fat burning beverage, a product for improving mental performance or preventing mental decline, or a skin improving product).

In certain embodiments, a package is provided containing a nutritional powder pod. In certain embodiments, a package is provided containing a plurality of nutritional powder pods. In certain embodiments, a kit is provided comprising a beverage production machine and one or more nutritional powder pods.

### Nutritional Powders

As discussed above, the nutritional powder pods of the present disclosure comprise a pod containing a nutritional powder. In certain embodiments, the nutritional powder contained within the pod is in the form of a flowable or substantially flowable powder. In certain embodiments, the nutritional powder is in the form of a powder that can be easily scooped and measured with a spoon or similar other device, such that the nutritional powder can accurately measured for reconstitution with a suitable liquid, typically water, to form a liquid product for immediate consumption. In this context, “immediate” consumption generally means within about 48 hours, more typically within about 24 hours, more typically within 12 hrs, more typically within 6 hours, in some embodiments within about 1 hour, and in some embodiments, immediately after reconstitution.

### Physical Properties of Nutritional Powders

The nutritional powders contained in the nutritional powder pods of the present disclosure may be characterized by certain physical properties. As discussed above, the nutritional powder of the nutritional powder pod has a specified powder porosity, as well as a specified vibrated bulk density. In certain embodiments, the nutritional powder of the nutritional powder pod has specified physical properties that include, but are not limited to, one or more of powder bulk density, powder porosity, particle size, particle size distribution, particle shape, and flowability index. Generally, such properties may impact the reconstitution of the nutritional powder contained in the pod into a liquid product by use of a beverage production machine.

As those skilled in the art will understand, powders, including nutritional powders, typically comprise both solid material (i.e., particles) and open space (i.e., total void volume). The open space that exists in nutritional in powders can be considered as sub-divided into at least two categories: space between different particles and space within a particle. Space within a particle can be considered as further subdivided into pores that have access to the surface of the particle (i.e., open pores) and pores that are located within the particle and isolated from the surface (i.e., closed pores).

Because nutritional powders typically include some amount of open space, determining the volume of a given portion of nutritional powder requires defined handling and measurement conditions. Generally, the total powder volume of a given portion of powder, i.e., the envelope volume plus the powder void volume, can be measured directly. However, because powders are compressible, the open space between the particles generally varies depending on how the powder is or has been handled. Therefore, the conditions under which the total powder volume is measured (e.g., loose powder, compressed powder, tapped powder, etc.) must be identified. Other measurements of powder volume (e.g., envelope volume, apparent volume, and true volume) can be calculated if other measurements such as total powder volume, powder void volume, interstitial void volume, and the volume of open and closed pores in the particle are known.

The bulk powder density of a given portion of a nutritional powder is the mass of the given portion of nutritional powder per its total powder volume. As discussed above, however, nutritional powders typically can be compressed to varying degrees, reducing the space between particles and changing the loose bulk density of the powder. Therefore, it is important to specify the conditions under which the powder bulk density is measured. Loose bulk density and tapped bulk density are two types of bulk density measurements generally known to those skilled in the art. Several industry standard methods for measuring these two bulk density values exist, including, but not limited to, ASTM D6683-14, “Standard Test Method for Measuring Bulk Density Values of Powders and Other Bulk Solids as a Function of Compressive Stress,” and GEA Niro Analytical Method A 2 A, “Powder Bulk Density.”

One specific type of bulk density measurement is vibrated bulk density according to the test method described more fully in the Test Methods section below. The advantage of measuring vibrated bulk density is that such measurements are generally reproducible and provide consistent results between operators.

As those skilled in the art will understand, there are various established methods for measuring the interstitial void volume or particle porosity of a given portion of a nutritional powder. The interstitial void volume of a given quantity of nutritional powder can be determined by volume or weight displacement of a non-solvating liquid or gas. Such techniques are accurate, although one must take care to eliminate any air bubble volume for the liquid displacement method, and the gas displacement method requires complex equipment. Other methods suitable for use in measuring the porosity of nutritional powders include mercury intrusion porosimetry which can be used to determine the envelope powder volume, the interstitial void volume, and the volume of open pores in the particles in a given portion of nutritional powder. Mercury intrusion porosimetry also allows estimation of the size of the open pores in the particles. In certain embodiment, mercury intrusion porosimetry is the preferred method for measuring the powder porosity of a given portion of a nutritional powder. One exemplary mercury intrusion porosimetry method is described more fully in the Test Methods section below.

Particle size can also be an important parameter for predicting nutritional powder behavior upon reconstitution into a liquid product. Generally, particles that are too large may blend poorly into liquids, dissolve slowly, or segregate from the rest of the powder. Generally, particles that are too small may tend to agglomerate and are subject to disruptive forces such as dusting or static dispersion. Nutritional powders typically have a range of particle sizes, as well. The particle size distribution (a curve plotting the particle size versus the number, weight, area, volume, or percent of particles at that size) is another parameter that can be indicative of nutritional powder behavior upon reconstitution into a liquid product. For individual particles that are relatively spherical or globular in size, the particle size can generally be reported as the diameter of the sphere. For individual particles that have other shapes that are asymmetric (e.g., rod or flake-shaped particles) or for agglomerated particles, reporting of the particle size can be more complex.

Particle shape can also be an important parameter for predicting nutritional powder behavior upon reconstitution to a liquid product. Relatively spherical or globular individual particles are easy to describe because of their symmetry. As those of skill in the art will understand, a number of methods have been used to describe non-spherical particles. One common measurement to describe and quantify non-spherical particles, particularly particles of elongated shape (i.e., rods), is the aspect ratio, which is the shortest dimension divided by the longest dimension. The morphology of the particles in the nutritional powder may be analyzed by various known processes, including, but limited to, by use of a Malvern Morphologi G3 particle characterization system, which measures the size and shape of particles via static image analysis.

The properties of a nutritional powder, including particle size, particle size distribution, and particle shape, can interact in complex ways to influence bulk nutritional powder properties, including bulk density, flowability, compression and settling. As those skilled in the art will understand, qualitative or quantitative relationships of easily determined properties are often used in an attempt to predict bulk powder behavior. One such relationship is the ratio of the vibrated bulk density to the loose bulk density of the nutritional powder. In certain embodiment, this ratio, also called a flowability index, can predict how well a particular nutritional powder will flow out of a container, along a trough or chute, through a pipe, and within other industrial equipment. Generally, a flowability index greater than about 2 indicates that a nutritional powder may have poor flowability. In certain embodiments, the nutritional powder of the nutritional powder pod has a flowability index of from about 1 to about 2, including about 1 to about 1.5, including about 1.1 to about 1.5, including about 1 to about 1.3.

### Nutritional Powder Reconstitution

In certain embodiments, the nutritional powder pods as described herein show good reconstitution of the nutritional powder contained within the pod, within the limitations of time, temperature, and liquid volume imposed by the beverage production machine.

In order to ensure adequate delivery of the ingredients in the nutritional powder, the nutritional powder is reconstituted with a defined amount of liquid. Generally, the liquid is mixed with the nutritional powder of the nutritional powder pod to reconstitute the nutritional powder into a liquid product. In certain embodiments, the liquid is passed into and through the nutritional powder pod, mixing with the nutritional powder to reconstitute it into a liquid product. In certain embodiments, the liquid is passed into the nutritional powder pod, mixing with the nutritional powder to reconstitute it into a liquid product. In certain embodiments, the liquid is injected into the nutritional powder pod, mixing with the nutritional product to reconstitute it into a liquid product.

In certain embodiments, the nutritional powders are reconstituted into a liquid product at a rate of from about 10 g to about 150 g of powder per 200 mL of liquid, including from about 20 g/200 mL to about 125 g/200 mL, including from about 20 g/200 mL to about 100 g/200 mL, including from about 20 g/200 mL to about 80 g/200 mL, including from about 20 g/200 mL to about 65 g/200 mL, including from about 20 g/200 mL to about 50 g/200 mL, including from about 25 g/200 mL to about 150 g/200 mL, including from about 25 g/200 mL to about 125 g/200 mL, including from about 25 g/200 mL to about 100 g/200 mL, including from about 25 g/200 mL to about 80 g/200 mL, including from about 25 g/200 mL to about 65 g/200 mL, including from about 25 g/200 mL to about 50 g/200 mL, including from about 40 g/200 mL to about 150 g/200 mL, including from about 40 g/200 mL to about 125 g/200 mL, including from about 40 g/200 mL to about 100 g/200 mL, including from about 40 g/200 mL to about 80 g/200 mL, including from about 40 g/200 mL to about 65 g/200 mL, including from about 40 g/200 mL to about 50 g/200 mL, including about 50 g/200 mL to about 150 g/200 mL, including about 50 g/200 mL to about 125 g/200 mL, including about 50 g/200 mL to about 100 g/200 mL, including from about 50 g/200 mL to about 80 g/200 mL, including from about 50 g/200 mL to about 65 g/200 mL, including from about 60 g/200 mL to about 150 g/200 mL, including from about 60 g/200 mL to about 125 g/200 mL, and including about 60 g/200 mL to about 100 g/200 mL. The nutritional powders may also be reconstituted at a rate of 10 g of powder per 200 mL of liquid, 20 g per 200 mL, 25 g per 200 mL, 30 g per 200 mL, 40 g per 200 mL, 50 g per 200 mL, 60 g per 200 mL, 65 g per 200 mL, 75 g per 200 mL, 80 g per 200 mL, 100 g per 200 mL, 125 g per 200 mL, and 150 g of powder per 200 mL of liquid.

Generally, when preparing a liquid product from a nutritional powder, it is desirable that the nutritional powder be accurately and fully incorporated into the liquid product. It can be undesirable, for instance, for there to be a residue of dry nutritional powder left at the bottom of a container or for the nutritional powder to form clumps that fail to reconstitute in the liquid product. This is particularly important with infant formulas, because these formulas typically provide the sole source or a supplemental source of nourishment to the infant. Generally, an infant formula powder must be fully reconstituted, so the infant receives a full serving of nutrients and calories provided by the formula. Additionally, any unreconstituted nutritional powder left within the nutritional powder pod is typically discarded, which is wasteful both economically and environmentally. As well, within a beverage production machine, any unreconstituted powder may create clumps that can deposit within or clog the inner workings of the machine, which can create sites for microbial growth and contamination or cause machine failure.

For these reasons, in certain embodiments, the nutritional powder in the nutritional powder pod is essentially reconstituted into the liquid product by the beverage preparation machine. In certain embodiments, essentially reconstituted means that at least 75% of the mass of the nutritional powder is reconstituted into the liquid product, including at least 80%, at least 85%, at least 90%, at least 92%, at least 95%, at least 98% and 75-100%, 75-95%, 75-90%, 75%-85%, 80-100%, 80-95%, 80-90%, 82%-100%, 82%-99%, 82%-98%, 85-100%, 85-95%, 85-90%, 90-100%, 90-98%, 90-95%, 92-100%, 92-98%, 92-95%, 95-100%, 95-98%, and 98-100% of the mass of the nutritional powder.

Generally a beverage production machine places certain limitations on the conditions under which reconstitution takes place. For example, the beverage production machine may inject a specified volume of liquid at a specified temperature into the nutritional powder pod. In certain exemplary embodiments, liquid is mixed with the nutritional powder from the pod at a temperature between about 5° C. and about 50° C., including about 5° C. to about 40° C., including about 5° C. to about 30° C., including about 5° C. to about 20° C., including about 5° C. to about 10° C., including about 10° C. to about 50° C., including about 20° C. to about 50° C., including about 30° C. to about 50° C., including about 40° C. to about 50° C. In certain of the same or other exemplary embodiments, the liquid is mixed with the nutritional powder at a pressure ranging from 0.5 bar to 15 bar, including from 0.5 bar to 10 bar, including from 0.5 bar to 7 bar, including from 0.5 bar to 5 bar, including from 0.5 bar to 2 bar, including 0.5 bar to 1 bar, including 1 bar to 10 bar, including 2 bar to 10 bar, including 3 bar to 10 bar, including 5 bar to 10 bar, and including 2 bar to 7 bar. In certain embodiments, the volume of the liquid product dispensed from the liquid product machine can range from about 5 mL to about 1,000 mL, including from about 25 mL to about 800 mL, including from about 50 mL to about 750 mL, including from about 50 mL to about 500 mL, including from about 50 mL to about 250 mL, including from about 50 mL to about 100 mL, including from about 100 mL to about 750 mL, including from about 100 mL to about 500 mL, including from about 100 mL to about 250 mL, including from about 250 mL to about 750 mL, and including from about 250 mL to about 500 mL. In certain embodiments, the liquid product dispensed from the liquid product machine falls within the temperature range of 5° to 50° C., including about 5° C. to about 40° C., including about 5° C. to about 30° C., including about 5° C. to about 20° C., including about 5° C. to about 10° C., including about 10° C. to about 50° C., including about 20° C. to about 50° C., including about 30° C. to about 50° C., including about 40° C. to about 50° C. In certain embodiments, the liquid product (i.e., the reconstituted beverage) is delivered in a sanitary manner to the receiving container (e.g., a bottle, sippy cup, mug, etc.), and the pod is thereafter discarded.

As discussed above, in certain embodiments, the loose bulk density of the nutritional powder within the nutritional powder pod is from about 0.2 g/cc to about 1 g/cc, including from about 0.28 g/cc to about 0.6 g/cc, including from about 0.3 g/cc to about 0.9 g/cc, including from about 0.35 g/cc to about 0.8 g/cc, including from about 0.4 g/cc to about 0.7 g/cc, and including about 0.5 g/cc to about 0.6 g/cc. In certain embodiments, the loose bulk density for the nutritional powder is about 0.2 g/cc, about 0.25 g/cc, about 0.28 g/cc, about 0.3 g/cc, about 0.35 g/cc, about 0.4 g/cc, about 0.5 g/cc, about 0.6 g/cc, about 0.7 g/cc, about 0.8 g/cc, about 0.9 g/cc, and about 1 g/cc. In certain embodiments, the nutritional powder has a vibrated bulk density from about 0.2 g/cc to about 1 g/cc, including from about 0.25 g/cc to about 0.95 g/cc, including from about 0.3 g/cc to about 0.9 g/cc, including from about 0.35 g/cc to about 0.8 g/cc, including from about 0.35 g/cc to about 0.75 g/cc, including from about 0.35 g/cc to about 0.74 g/cc, including from about 0.4 g/cc to about 0.75 g/cc, and including about 0.5 g/cc to about 0.75 g/cc. In certain embodiments, the vibrated bulk densities for the nutritional powder is about 0.2 g/cc, about 0.25 g/cc, about 0.3 g/cc, about 0.35 g/cc, about 0.4 g/cc, about 0.45 g/cc, about 0.5 g/cc, about 0.55 g/cc, about 0.6 g/cc, about 0.65 g/cc, about 0.7 g/cc, about 0.74 g/cc, about 0.75 g/cc, about 0.8 g/cc, about 0.85 g/cc, about 0.9 g/cc, about 0.95 g/cc, and about 1 g/cc. In a preferred embodiment, the nutritional powder has vibrated bulk density of from about 0.3 g/cc to about 0.8 g/cc.

As discussed above, in certain embodiments, the nutritional powder of the nutritional powder pod has a powder porosity of from about 5% to about 80%. In certain embodiments, the nutritional powder has a powder porosity of from about 10 to about 80%, including from about 20% to about 80%, including from about 25% to about 78%, including from about 30% to about 76%, including from about 35% to about 75%, including from about 37% to about 67%, including from about 40% to about 75%, including from about 45% to about 75%, including from about 50% to about 72%, including from about 50% to about 70%, and including from about 52% to about 67%. In certain embodiments, the nutritional powder has a powder porosity of about 5%, about 10%, about 15%, about 20%, about 25%, about 30%, about 35%, about 37%, about 40%, about 45%, about 50%, about 52%, about 55%, about 60%, about 65%, about 67%, about 70%, about 75%, and about 80%. In a preferred embodiment, the powder porosity is in the range of from about 35% to about 70%.

To improve the reconstitution of the nutritional powder in the nutritional powder pod, it has been found that the particles should have an average particle size from about 25 μm to about 1000 μm in diameter, including from about 25 μm to about 750 μm, including from about 25 μm to about 500 μm, including from about 25 μm to about 400 μm, including from about 25 μm to about 200 μm, including from about 40 μm to about 1000 μm, including from about 40 μm to about 750 μm, including from about 40 μm to about 500 μm, including from about 40 μm to about 400 μm, including from about 40 μm to about 200 μm, including from about 60 μm to about 1000 μm, including from about 60 μm to about 750 μm, including from about 60 μm to about 500 μm, including from about 60 μm to about 600 μm, including from about 60 μm to about 400 μm, including from about 60 μm to about 200 μm, including from about 80 μm to about 1000 μm, including from about 80 μm to about 750 μm, including from about 80 μm to about 500 μm, including from about 80 μm to about 400 μm, including from about 80 μm to about 200 μm, including from about 100 μm to about 1000 μm, including from about 100 μm to about 750 μm, including from about 100 μm to about 500 μm, including from about 100 μm to about 400 μm, including from about 100 μm to about 200 μm, and including from about 150 μm to about 400 μm. Suitable average particle sizes include about 25 μm, about 40 μm, about 60 μm, about 80 μm, about 100 μm, about 125 μm, about 150 μm, about 175 μm, about 200 μm, about 250 μm, about 300 μm, about 350 μm, about 400 μm, about 450 μm, about 500 μm, about 550 μm, about 600 μm, about 650 μm, about 700 μm, about 800 μm, about 900 μm, and about 1000 μm. In a preferred embodiment, the average particle size should be from about 75 μm to about 400 μm.

In certain embodiments, the nutritional powder of the nutritional powder pod has a particle size distribution where at least about 80% by number of the particles are from about 10 μm to about 2000 μm in diameter. In certain embodiments, the nutritional powder has a particle size distribution where at least about 80% by number of the particles are from about 25 μm to about 2000 μm, including from about 25 μm to about 1500 μm, including from about 25 μm to about 1000 μm, including from about 25 μm to about 500 μm, including from about 50 μm to about 2000 μm, including from about 50 μm to about 1500 μm, including from about 50 μm to about 1000 μm, including from about 50 μm to about 500 μm, including from about 75 μm to about 2000 μm, including from about 75 μm to about 1500 μm, including from about 75 μm to about 1000 μm, including from about 75 μm to about 500 μm, including from about 100 μm to about 2000 μm, including from about 100 μm to about 1500 μm, including from about 100 μm to about 1250 μm, including from about 100 μm to about 1000 μm, including from about 100 μm to about 500 μm, including from about 125 μm to about 2000 μm, including from about 125 μm to about 1500 μm, including from about 125 μm to about 1000 μm, and including from about 125 μm to about 500 μm. In preferred embodiments, at least about 60% by number of the nutritional powder particles have particle sizes from about 10 μm to about 1000 μm, including from about 10 μm to about 750 μm, including from about 10 μm to about 500 μm, including from about 25 μm to about 1000 μm, including from about 25 μm to about 750 μm, including from about 25 μm to about 500 μm, including from about 25 μm to about 400 μm, including from about 40 μm to about 1000 μm, including from about 40 μm to about 750 μm, including from about 40 μm to about 600 μm, including from about 40 μm to about 500 μm, including from about 40 μm to about 400 μm, including from about 50 μm to about 1000 μm, including from about 50 μm to about 750 μm, including from about 50 μm to about 600 μm, including from about 50 μm to about 500 μm, including from about 50 μm to about 400 μm, including from about 60 μm to about 1000 μm, including from about 60 μm to about 750 μm, including from about 60 μm to about 600 μm, including from about 60 μm to about 500 μm, including from about 60 μm to about 400 μm, including from about 70 μm to about 1000 μm, including from about 70 μm to about 750 μm, including from about 70 μm to about 600 μm, including from about 70 μm to about 500 μm, and including from about 70 μm to about 400 μm. In a preferred embodiment, the nutritional powder of the nutritional powder pod has a particle size distribution where at least about 80% by number of the particles are from about 10 μm to about 800 μm in diameter.

To have good reconstitution of the nutritional powder in the nutritional powder pod, it has been found that preferred particle shapes include, but are not limited to, spheres, spheroids, cubes, cuboids, plates, flakes, rods, threads, and combinations thereof. In some embodiments, the particle shapes in the nutritional powders should have aspect ratios from about 0.3 to about 1, from about 0.4 to about 1, from about 0.5 to about 1, from about 0.6 to about 1, from about 0.65 to about 0.9, from about 0.7 to about 1, from about 0.7 to about 0.9, from about 0.74 to about 0.87, from about 0.8 to about 1, or from about 0.8 to about 0.9. In a preferred embodiment, the aspect ratio of the nutritional powder particles should be from about 0.7 to about 1.

To have good reconstitution of the nutritional powder in the nutritional powder pod, it has been found that the flowability index for the nutritional powder should be about 1 to about 2. Suitable values for the flowability index include about 1, about 1.1, about 1.2, about 1.3, about 1.4, about 1.5, about 1.6, about 1.7, about 1.8, about 1.9, and about 2. In preferred embodiments, the flowability index should be from about 1 to about 1.5.

The reconstitution of the nutritional powder may be tested using the Nutritional Powder Reconstitution Test below. A nutritional powder is deemed to have good reconstitution if the reconstitution yield is at least about 75 weight % of the nutritional powder, including at least about 80%, including at least about 85%, including at least about 90%, including at least about 92%, including at least about 95%, including at least about 97%, including at least about 98%, including at least about 99% of the nutritional powder. The Nutritional Powder Reconstitution Test can also determine the rate of reconstitution. Suitable rates of reconstitution from about 0.1 mg/g-s to about 30 mg/g-s, including from about 0.1 mg/g-sec to about 25 mg/g-sec, including from about 0.1 mg/g-sec to about 20 mg/g-sec, including from about 0.1 mg/g-sec to about 15 mg/g-sec, including from about 0.1 mg/g-sec to about 10 mg/g-sec, including from about 0.2 mg/g-sec to about 25 mg/g-sec, including from about 0.2 mg/g-sec to about 20 mg/g-sec, including from about 0.2 mg/g-sec to about 15 mg/g-sec, including from about 0.3 mg/g-sec to about 25 mg/g-sec, including from about 0.3 mg/g-sec to about 24 mg/g-sec, including from about 0.3 mg/g-sec to about 20 mg/g-sec, including from about 0.3 mg/g-sec to about 15 mg/g-sec, including from about 0.4 mg/g-sec to about 25 mg/g-sec, including from about 0.4 mg/g-sec to about 20 mg/g-sec, including from about 0.4 mg/g-sec to about 15 mg/g-sec, including from about 0.4 mg/g-sec to about 10 mg/g-sec, including from about 0.5 mg/g-sec to about 25 mg/g-sec, and including from about 0.5 mg/g-sec to about 20 mg/g-sec.

The nutritional powder may comprise a wettability of about 1 second to about 200 seconds. The wettability of the nutritional powder is important on the overall flow performance of the nutritional formula through the nutrient delivery system. The wettability of the nutritional powder may be measured indirectly by adding a powder to the surface of water in a container (e.g., a beaker) and recording the time it takes for the powder to fall below the surface. The wettability may be about 1 second to about 120 seconds, 1 second to about 60 seconds, about 2 seconds to about 30 seconds, about 1 second to about 5 seconds, and about 2 seconds to about 5 seconds.

The liquid product from the reconstituted nutritional powder may comprise a Hunter Lab “L” value between about 20 and about 100. The Hunter Lab “L” value is a measurement of the lightness of the liquid product. The Hunter Lab “L” value of the liquid product can be measured by a spectrophotometer, which allows quantitative measurement of the reflection or transmission properties of the liquid product as a function of wavelength. The Hunter Lab “L” value of the liquid product may be about 25 to about 90, about 30 to about 80, about 40 to about 70, or about 50 to about 60.

The liquid product from the reconstituted nutritional powder may comprise a Hunter Lab “a” value between about −5.00 and about 1.00. The Hunter Lab “a” value is a measurement of the color-opponent dimension of a liquid product. The Hunter Lab “a” value of the liquid product can be measured by a spectrophotometer, which allows quantitative measurement of the reflection or transmission properties of the liquid product as a function of wavelength. The Hunter Lab “a” value of the liquid product may be about −4.50 to about 1.00, about −4.00 to about −0.50, about −3.50 to about −1.00, about −3.00 to about −1.50, and about −2.50 to about −2.00.

The liquid product from the reconstituted nutritional powder may comprise a Hunter Lab “b” value between about 1 and about 30. The Hunter Lab “b” value is a measurement of the color-opponent dimension of a liquid product. The Hunter Lab “b” value of the liquid product can be measured by a spectrophotometer, which allows quantitative measurement of the reflection or transmission properties of the liquid product as a function of wavelength. The Hunter Lab “b” value of the liquid product may be about 2 to about 25, about 5 to about 20, about 7 to about 17, about 8 to about 15, about 9 to about 12, or about 5 to about 10.

### Composition of Nutritional Powders

In certain embodiments, the composition of the nutritional powder contained in the nutritional powder pod is one of the following: an infant formula, a pediatric formula, an adult nutritional formula, a preterm infant formula, an elemental formula, a semi-elemental formula, or a nutritional supplement. In certain embodiments, when the nutritional powder is an infant formula, the nutritional powder pod, the packaging for the nutritional powder pods, or both are labeled with information indicating that the formula within is an infant formula and is intended for consumption by infants. In certain embodiments, when the nutritional powder is a pediatric formula, the nutritional powder pod, the packaging for the nutritional powder pods, or both are labeled with information indicating that the formula within is a pediatric formula and is intended for consumption by toddlers, children, or both. In certain embodiments, when the nutritional powder is an adult nutritional formula, the nutritional powder pod, the packaging for the nutritional powder pods, or both are labeled with information indicating that the formula within is an adult nutritional formula and is intended for consumption by adults. In certain embodiments, when the nutritional powder is an adult formula, the nutritional powder includes one or more flavorings, examples of which include, but are not limited to vanilla, chocolate, fruit flavors, vegetable flavors, coffee, and butter pecan.

In certain embodiments, the nutritional powder may be formulated with sufficient kinds and amounts of nutrients so as to provide a sole, primary, or supplemental source of nutrition for the individual for whom the liquid product is intended (i.e., an infant, a toddler, a child or an adult).

Generally, nutritional powders have a caloric density tailored to the nutritional needs of the ultimate user. In typical instances, nutritional powders may comprise from about 65 to about 800 kcal/100 g, including from about 90 to about 550 kcal/100 g, and also including from about 150 to about 550 kcal/100 g. Other caloric densities are within the scope of the present disclosure.

### Macronutrients

As discussed above, in certain embodiments, the nutritional powder comprises one or more macronutrients selected from the group of protein, carbohydrate, fat, and mixtures thereof. In certain embodiments, the nutritional powders comprise at least one source of protein, at least one source of carbohydrate, and at least one source of fat. Generally, any source of protein, carbohydrate, or fat that is suitable for use in nutritional products is also suitable for use herein, provided that such macronutrients are also compatible with the essential elements of the nutritional powders as defined herein.

Although total concentrations or amounts of protein, carbohydrates, and fat may vary depending upon the nutritional needs of the particular individual for whom the nutritional powder is formulated, such concentrations or amounts most typically fall within one of the following embodied ranges, inclusive of any other essential protein, carbohydrate, or fat ingredients as described herein.

In certain embodiments, when the nutritional powder is formulated as an infant formula, the protein component is typically present in an amount of from about 5% to about 35% by weight of the infant formula (i.e., the powder infant formula), including from about 10% to about 30%, from about 10% to about 25%, from about 15% to about 25%, from about 20% to about 30%, from about 15% to about 20%, and also including from about 10% to about 16% by weight of the infant formula (i.e., the powder infant formula). The carbohydrate component is typically present in an amount of from about 40% to about 75% by weight of the infant formula (i.e., the powder infant formula), including from about 45% to about 75%, from about 45% to about 70%, from about 50% to about 70%, from about 50% to about 65%, from about 50% to about 60%, from about 60% to about 75%, from about 55% to about 65%, and also including from about 65% to about 70% by weight of the infant formula (i.e., the powder infant formula). The fat component is typically present in an amount of from about 10% to about 40% by weight of the infant formula (i.e., the powder infant formula), including from about 15% to about 40%, from about 20% to about 35%, from about 20% to about 30%, from about 25% to about 35%, and also including from about 25% to about 30% by weight of the infant formula (i.e., the powder infant formula).

In certain embodiments, when the nutritional powder is formulated as a pediatric formula, the protein component is typically present in an amount of from about 5% to about 30% by weight of the pediatric formula (i.e., the powder pediatric formula), including from about 10% to about 25%, from about 10% to about 20%, from about 10% to about 15%, from about 15% to about 20%, and also including from about 12% to about 20% by weight of the pediatric formula (i.e., the powder pediatric formula). The carbohydrate component is typically present in an amount of from about 40% to about 75% by weight of the pediatric formula, including from about 45% to about 70%, from about 50% to about 70%, from about 55% to about 70%, and also including from about 55% to about 65% by weight of the pediatric formula (i.e., the powder pediatric formula). The fat component is typically present in an amount of from about 10% to about 25% by weight of the pediatric formula, including from about 12% to about 20%, and also including from about 15% to about 20% by weight of the pediatric formula (i.e., the powder pediatric formula).

Additional suitable ranges for proteins, carbohydrates, and fats in those embodiments where the nutritional powder is formulated as an infant formula or a pediatric formula, based on the percentage of total calories of the nutritional powder, are set forth in Table 1.

TABLE 1

| | Embodiment A | Embodiment B | Embodiment C |
|---|---|---|---|
| Macronutrient | (% Calories) | (% Calories) | (% Calories) |
| Protein | 2-75 | 5-50 | 7-40 |
| Carbohydrate | 1-85 | 30-75 | 35-65 |
| Fat | 5-70 | 20-60 | 25-50 |

Note:
Each numerical value in the table is preceded by the term “about.”

In certain embodiments, when the nutritional powder is formulated as an adult nutritional product, the protein component is typically present in an amount of from about 5% to about 35% by weight of the adult nutritional product, including from about 10% to about 30%, from about 10% to about 20%, from about 15% to about 20%, and including from about 20% to about 30% by weight of the adult nutritional product. The carbohydrate component is typically present in an amount of from about 40% to about 80% by weight of the adult nutritional product, including from about 50% to about 75%, from about 50% to about 65%, from about 55% to about 70%, and also including from 60% to 75% by weight of the adult nutritional product. The fat component is typically present in an amount of from about 0.5% to about 20%, including from about 1% to about 15%, from about 1% to about 10%, from about 1% to about 5%, from about 5% to about 20%, from about 10% to about 20%, and also including from about 15% to about 20% by weight of the adult nutritional product.

Additional suitable ranges for proteins, carbohydrates, and fats in those embodiments where the nutritional powder is formulated as an adult nutritional product, based on the percentage of total calories of the nutritional powder, are set forth in Table 2.

TABLE 2

| | Embodiment A | Embodiment B | Embodiment C |
|---|---|---|---|
| Macronutrient | (% Calories) | (% Calories) | (% Calories) |
| Protein | 1-98 | 5-80 | 15-55 |
| Carbohydrate | 1-98 | 0-75 | 20-50 |
| Fat | 1-98 | 20-70 | 25-40 |

Note:
Each numerical value in the table is preceded by the term “about.”

In certain embodiments, the nutritional powder includes protein or a source of protein. Generally, any source of protein may be used so long as it is suitable for oral nutritional compositions and is otherwise compatible with any other selected ingredients or features in the nutritional composition. Non-limiting examples of suitable proteins (and sources thereof) suitable for use in the nutritional powders described herein include, but are not limited to, intact, hydrolyzed, or partially hydrolyzed protein, which may be derived from any known or otherwise suitable source such as milk (e.g., casein, whey), animal (e.g., meat, fish), cereal (e.g., rice, corn, wheat), vegetable (e.g., soy, pea, potato, bean), and combinations thereof. The protein may also include a mixture of amino acids (often described as free amino acids) known for use in nutritional products or a combination of such amino acids with the intact, hydrolyzed, or partially hydrolyzed proteins described herein. The amino acids may be naturally occurring or synthetic amino acids.

More particular examples of suitable protein (or sources thereof) used in the nutritional powders disclosed herein include, but are not limited to, whole cow's milk, partially or completely defatted milk, milk protein concentrates, milk protein isolates, nonfat dry milk, condensed skim milk, whey protein concentrates, whey protein isolates, acid caseins, sodium caseinates, calcium caseinates, potassium caseinates, legume protein, soy protein concentrates, soy protein isolates, pea protein concentrates, pea protein isolates, collagen proteins, potato proteins, rice proteins, wheat proteins, canola proteins, quinoa, insect proteins, earthworm proteins, fungal (e.g., mushroom) proteins, hydrolyzed yeast, gelatin, bovine colostrum, human colostrum, glycomacropeptides, mycoproteins, proteins expressed by microorganisms (e.g., bacteria and algae), and combinations thereof. The nutritional powders described herein may include any individual source of protein or combination of the various sources of protein listed above.

In addition, the proteins for use herein can also include, or be entirely or partially replaced by, free amino acids known for use in nutritional products, non-limiting examples of which include L-tryptophan, L-glutamine, L-tyrosine, L-methionine, L-cysteine, taurine, L-arginine, L-carnitine, and combinations thereof.

In certain embodiments, the nutritional powders described herein include a protein component that consists of only intact or partially hydrolyzed protein; that is, the protein component is substantially free of any protein that has a degree of hydrolysis of 25% or more. In this context, the term “partially hydrolyzed protein” refers to proteins having a degree of hydrolysis of less than 25%, including less than 20%, including less than 15%, including less than 10%, and including proteins having a degree of hydrolysis of less than 5%. The degree of hydrolysis is the extent to which peptide bonds are broken by a hydrolysis chemical reaction. To quantify the partially hydrolyzed protein component of these embodiments, the degree of protein hydrolysis is determined by quantifying the amino nitrogen to total nitrogen ratio (AN/TN) of the protein component of the selected nutritional powder. The amino nitrogen component is quantified by USP titration methods for determining amino nitrogen content, while the total nitrogen component is determined by the Tecator® Kjeldahl method. These analytical methods are well known.

In certain embodiments, the nutritional powder includes a carbohydrate or a source of carbohydrate. The carbohydrate or source of carbohydrate suitable for use in the nutritional powders disclosed herein may be simple, complex, or variations or combinations thereof. Generally, the carbohydrate may include any carbohydrate or carbohydrate source that is suitable for use in oral nutritional compositions and is otherwise compatible with any other selected ingredients or features in the nutritional powder. It should be noted, however, that the inventors have discovered that certain carbohydrates, when used at high concentrations, may be unsuitable for the nutritional powders of the present disclosure, because these carbohydrates may cause plugging in the beverage production machine. For example, it has been found that nutritional powders containing some types of rice starch at a concentration of about 15% or more of the total weight of the nutritional powder are more prone to plugging the beverage production machine, and therefore should be avoided.

Non-limiting examples of carbohydrates suitable for use in the nutritional powders described herein include, but are not limited to, polydextrose, maltodextrin; hydrolyzed or modified starch or cornstarch; glucose polymers; corn syrup; corn syrup solids; sucrose; glucose; fructose; lactose; high fructose corn syrup; honey; sugar alcohols (e.g., maltitol, erythritol, sorbitol); isomaltulose; sucromalt; pullulan; potato starch; and other slowly-digested carbohydrates; dietary fibers including, but not limited to, fructooligosaccharides (FOS), galactooligosaccharides (GOS), oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinogalactans, glucomannan, xanthan gum, alginate, pectin, low methoxy pectin, high methoxy pectin, cereal beta-glucans (e.g., oat beta-glucan, barley beta-glucan), carrageenan and psyllium, digestion resistant maltodextrin (e.g., Fibersol™, a digestion-resistant maltodextrin, comprising soluble dietary fiber); soluble and insoluble fibers derived from fruits or vegetables; other resistant starches; and combinations thereof. The nutritional powders described herein may include any individual source of carbohydrate or combination of the various sources of carbohydrate listed above.

In certain embodiments, the nutritional powder includes a fat or a source of fat. The fat or source of fat suitable for use in the nutritional powders described herein may be derived from various sources including, but not limited to, plants, animals, and combinations thereof. Generally, the fat may include any fat or fat source that is suitable for use in oral nutritional compositions and is otherwise compatible with any other selected ingredients or features in the nutritional powder. Non-limiting examples of suitable fat (or sources thereof) for use in the nutritional powders disclosed herein include coconut oil, fractionated coconut oil, soy oil, high oleic soy oil, corn oil, olive oil, safflower oil, high oleic safflower oil, medium chain triglyceride oil (MCT oil), high gamma linolenic (GLA) safflower oil, sunflower oil, high oleic sunflower oil, palm oil, palm kernel oil, palm olein, canola oil, high oleic canola oil, marine oils, fish oils, algal oils, borage oil, cottonseed oil, fungal oils, eicosapentaenoic acid (EPA), docosahexaenoic acid (DHA), arachidonic acid (ARA), conjugated linoleic acid (CLA), alpha-linolenic acid, rice bran oil, wheat bran oil, interesterified oils, transesterified oils, structured lipids, and combinations thereof. Generally, the fats used in nutritional powders for formulating infant formulas and pediatric formulas provide fatty acids needed both as an energy source and for the healthy development of the infant, toddler, or child. These fats typically comprise triglycerides, although the fats may also comprise diglycerides, monoglycerides, and free fatty acids. Fatty acids provided by the fats in the nutritional powder include, but are not limited to, capric acid, lauric acid, myristic acid, palmitic acid, palmitoleic acid, stearic acid, oleic acid, linoleic acid, alpha-linolenic acid, ARA, EPA, and DHA. The nutritional powders can include any individual source of fat or combination of the various sources of fat listed above.

### Optional Ingredients

In certain embodiments, the nutritional powders described herein may further comprise other optional ingredients that may modify the physical, chemical, hedonic, or processing characteristics of the products or serve as additional nutritional components when used for a targeted population. Many such optional ingredients are known or otherwise suitable for use in other nutritional products and may also be used in the nutritional powders described herein, provided that such optional ingredients are safe and effective for oral administration and are compatible with the essential and other ingredients in the selected product form.

Non-limiting examples of such optional ingredients include preservatives, antioxidants, emulsifying agents, buffers, additional nutrients as described herein, colorants, flavors (natural, artificial, or both), thickening agents, flow agents, anti-caking agents, and stabilizers.

In certain embodiments, the nutritional powders further comprise minerals, non-limiting examples of which include calcium, phosphorus, magnesium, iron, zinc, manganese, copper, sodium, potassium, molybdenum, chromium, selenium, chloride, and combinations thereof.

In certain embodiments, the nutritional powders further comprise vitamins or related nutrients, non-limiting examples of which include vitamin A, vitamin D, vitamin E, vitamin K, thiamine, riboflavin, pyridoxine, vitamin B12, niacin, folic acid, pantothenic acid, biotin, vitamin C, choline, inositol, salts and derivatives thereof, and combinations thereof.

The certain embodiments, the nutritional powders include one or more masking agents to reduce or otherwise obscure bitter flavors and after taste. Suitable masking agents include natural and artificial sweeteners, natural and artificial flavors, sodium sources such as sodium chloride, and hydrocolloids, such as guar gum, xanthan gum, carrageenan, gellan gum, and combinations thereof. Generally, the amount of masking agent in the nutritional powder may vary depending upon the particular masking agent selected, other ingredients in the nutritional powder, and other nutritional powder or product target variables. Such amounts, however, most typically range from at least 0.1 wt %, including from about 0.15 wt % to about 3 wt %, and also including from about 0.18 wt % to about 2.5 wt %, by weight of the nutritional powder.

In certain embodiments, the nutritional powders include at least one wetting agent. Generally, wetting agents act to improve and hasten the interaction between the nutritional powder and the impinging liquid, typically water, supplied by the beverage production machine. The wetting agent thus assists in quickly reconstituting the nutritional powder into a suitable liquid product. Suitable wetting agents include phospholipids, mono- and diglycerides, mono- and diglyceride oil, diacetyl tartaric acid ester of mono- and diglycerides (DATEM), and other emulsifiers and surfactants.

In certain embodiments, the nutritional powders include at least one anti-caking agent. Generally, these agents help to maintain the powder particles as loose, free-flowing particles with a reduced tendency to form large clumps as the powder sits over time. Suitable anti-caking agents include silicon dioxide.

In certain embodiments, the nutritional powder comprises a compound selected from the group of leucine, beta-alanine, epigallocatechin gallate, human milk oligosaccharides, prebiotics, probiotics, nucleotides, nucleosides, carotenoids (e.g., lutein, beta-carotene, lycopene, and zeaxanthin), beta-hydroxy-beta-methylbutyrate (HMB), and combinations thereof. Although calcium HMB monohydrate is the preferred source of HMB for use herein, other suitable sources may include HMB as the free acid, a salt, an anhydrous salt, an ester, a lactone, or other product forms that otherwise provide a bioavailable form of HMB from the nutritional product.

### Methods of Manufacture

As discussed above, certain embodiments of the present disclosure relate to methods of making a nutritional powder pod for use in a liquid product or beverage production machine. The nutritional powder pod comprises a nutritional powder that is produced from a mixture comprising one or more of a protein, a carbohydrate, a fat, a vitamin, and a mineral. The mixture is dried to form the nutritional powder, and then packaged into a pod. The nutritional powder comprises particles, wherein the nutritional powder has a vibrated bulk density from about 0.2 g/cc to about 1 g/cc and a powder porosity from about 5% to about 80%.

In certain embodiments, the methods include a further step of introducing a gas into the mixture. In certain embodiments, the methods include a further step of milling the nutritional powder. In certain embodiments, the drying includes spray-drying. In certain embodiments, the nutritional powder is produced by extrusion.

Generally, nutritional powders suitable for use in nutritional powder pods may be prepared by any process or suitable method for making a nutritional powder. In some embodiments, the nutritional powders may include spray dried powders, dry blended powders, agglomerated powders, extruded powders, milled powders, powders prepared by other suitable methods, or combinations thereof. In certain embodiments, the process of preparing the nutritional powders includes spray drying, dry blending, agglomerating, extruding, milling, and combinations thereof.

In one suitable manufacturing process for preparing nutritional powders suitable for use in the nutritional powder pods described herein, at least three separate slurries are prepared, including a protein-in-fat (PIF) slurry, a carbohydrate-mineral (CHO-MIN) slurry, and a protein-in-water (PIW) slurry. The PIF slurry is formed by heating and mixing an oil (e.g., soy oil, canola oil, or corn oil) and then adding an emulsifier (e.g., lecithin), fat soluble vitamins, and at least a portion of the total protein (e.g., milk protein concentrate) with continued heat and agitation. The CHO-MIN slurry is formed by adding to water, with heat and agitation, minerals (e.g., potassium citrate, dipotassium phosphate, or sodium citrate), including trace minerals (TM) and ultra trace minerals (UTM) (e.g., a TM/UTM premix), and thickening or viscosity agents (e.g., cellulose gel, gellan, or carrageenan). The resulting slurry is held for 10 minutes with continued heat and agitation before adding additional minerals (e.g., potassium chloride, magnesium carbonate, or potassium iodide) and the carbohydrates (e.g., sucrose or corn syrup) to complete the CHO-MN slurry. The PIW slurry is formed by mixing water and the remaining protein with heat and agitation.

In accordance with this process, the three slurries are mixed together with heat and agitation to form a nutritional emulsion. The pH of the nutritional emulsion is adjusted to the desired range, e.g., from 6.6 to 7.5 (including 6.6 to 7), after which the nutritional emulsion is subjected to high-temperature short-time (HTST) processing (i.e., about 165° F. (74° C.) for about 16 seconds) or an ultra high temperature (UHT) processing step (i.e., about 292° F. (144° C.) for about 5 seconds). The nutritional emulsion is heat treated, emulsified, homogenized, and cooled during the HTST or UHT process. Water soluble vitamins and ascorbic acid are added (if applicable), and the pH is again adjusted (if necessary). The batch is evaporated, heat treated, and spray dried. After drying, the powder may be transported to storage hoppers. The base powder may be dry blended with the remaining ingredients to form the nutritional powder. The nutritional powder is then packaged in appropriate containers (i.e., pods, packages containing one or more pods, or kits containing one or more pods) for distribution. Those of skill in the art will understand that standard intermediate manufacturing steps, such as bulk storage, packing in large bags or drums, transport to other locations, etc., may be incorporated as part of this process.

In certain embodiments, the nutritional emulsion is dried to form a nutritional powder using any methods known in the art. By way of example, nutritional powders can be manufactured by preparing at least two slurries, which are then mixed, heat treated, standardized, heat treated a second time, evaporated to remove water, and spray dried or dry blended to form a reconstitutable nutritional powder.

One exemplary method of preparing a spray dried nutritional powder suitable for use in the nutritional powder pods disclosed herein comprises forming and homogenizing an aqueous slurry or liquid comprising predigested fat, and optionally protein, carbohydrate, and other sources of fat, and then spray drying the slurry or liquid to produce a spray dried nutritional powder. The method may further comprise the step of spray drying, dry mixing, or otherwise adding additional nutritional ingredients, including any one or more of the ingredients described herein, to the spray dried nutritional powder.

Generally, when the nutritional powder for use in the nutritional powder pod is a spray dried nutritional powder or a dry blended nutritional powder, it may be prepared by any suitable known techniques. For example, the spray drying may include any spray drying technique that is suitable for use in the production of nutritional powders. Many different spray drying methods and techniques are known for use in the nutrition field, all of which are suitable for use in the manufacture of the spray dried nutritional powders herein. Following drying, the finished powder may be packaged into nutritional powder pods.

In other embodiments, the preparation of the nutritional powder comprises an extruded powder. Milling can also be included as a step in preparing the nutritional powder.

In certain embodiments, the ingredients of the nutritional powder may be extruded as part of the process of making the nutritional powder. In certain embodiments, the ingredients are incorporated in the extruder hopper in the form of a dry feed or powder premix. The dry nutritional ingredients enter the extruder just after the point of entry of water. In certain embodiments, the water comprises from about 1% to about 80% by weight of the total weight of the water and dry ingredients. The amount of water added to the nutritional composition may be adjusted within the aforementioned ranges based on the desired physical properties of the extrudate. In certain embodiments, the nutritional ingredients may be premixed with water to form a thick emulsion, which is then fed into the extruder hopper in the form of a viscous liquid or sludge. The term “extrudate” refers to all or a portion of a nutritional composition that exits an extruder.

In certain embodiment, the extruder used to produce the nutritional powder or extrudate operates in a continuous format. Generally, any extruder known for use in food processing may be utilized. In certain embodiments, extrusion is performed via a screw extruder. Said screw extruder may be a twin screw extruder or a single screw extruder. The extruder screws may consist of shear elements, mixing elements, conveying elements, kneading elements, emulsifying elements, disc elements, or a combination of the above in any interchangeable order. The barrels of the extruder may be steam heated or electrically heated. In certain embodiments, extrusion takes place at a temperature between about 25° C. to about 225° C., from about 50° C. to about 125° C., or from about 70° C. to about 100° C. In certain embodiments, the ingredients are processed in the extruder for about 5 seconds to about 240 seconds or for about 30 seconds to about 180 seconds.

In certain embodiments disclosed herein, the extrudate is dried following extrusion so as to remove most or all of the water contained therein. In such embodiments, any conventional drying methods may be used to remove the desired amount of water from the nutritional powder. For example, the nutritional powder extrudate may be dried using a vacuum, convective hot air, a tray dryer, infrared, or any combination of the above. In certain embodiments, the nutritional powder extrudate may be further ground or milled to a desired particle size following drying. In certain embodiments, additional protein and carbohydrate ingredients may be added to the final nutritional powder in the form of dry ingredients or a dry blend.

In certain embodiment, in order to increase or enhance the particle porosity or powder porosity of the nutritional powder, a pressurized gas may be introduced into the nutritional emulsion at a suitable time during the manufacturing process. This pressurized gas may dissolve into the nutritional emulsion during the blending stages if these stages are similarly conducted under pressure. During the spray-drying or extrusion stages, though, the pressure may be reduced, allowing the depressurized gas to bubble out of the particles of nutritional powder that are being formed at this stage. The exiting gas bubbles may leave a greater number of open pores or expanded open pores in the nutritional powder particles.

In certain embodiments, after the nutritional powder is packaged into the pod, the pod is sealed and then stored under ambient conditions or under refrigeration for up to 36 months or longer, more typically from about 6 months to about 24 months. The nutritional powder may be contained in the pod such that a headspace in the pod includes a maximum of about 10% O₂ (i.e., less than or equal to about 10% O₂), thereby reducing oxidation of the nutritional powder or formula and preventing the development of undesirable flavors, smells, and textures. In certain embodiments, a package is provided containing a plurality of nutritional powder pods. In certain embodiments, a package containing a plurality of nutritional powder pods is prepared and stored.

### Methods of Use

In certain embodiments, an individual consumes one or more servings of the liquid product made using the nutritional powder pods in a beverage production machine. The serving size may be different for different types of individuals, depending on one or more factors including, but not limited to, age, body mass, gender, species, or health.

In these embodiments, an individual desirably consumes at least one serving of the liquid product made using the nutritional powder pods per day, and in some embodiments, may consume two, three, or even more servings per day. Each serving is desirably administered as a single undivided dose, although the serving may also be divided into two or more partial or divided servings to be taken at two or more times during the day.

The methods of the present disclosure include continuous day after day administration, as well as periodic or limited administration, although continuous day after day administration is generally desirable. The liquid product made using the nutritional powder pods may be used by infants, toddlers, children, adolescents, and adults.

In certain embodiments of the present disclosure, methods of making a nutritional powder pod for use in a liquid product or beverage production machine is provided. The nutritional powder pod comprises a nutritional powder and the method comprises the steps of: producing a mixture comprising at least one nutritional ingredient; drying the mixture to form a nutritional powder; and packaging the nutritional powder into a pod. The nutritional powder has a vibrated bulk density from about 0.2 g/cc to about 1 g/cc and a powder porosity of from about 5% to about 80%.

### Test Methods

The following discussion of test methods that is provided should be considered to be exemplary only and not construed to be limiting upon the present disclosure. Specifically, other test methods and variations of the provided test methods may be used, in certain embodiments, to measure the same physical properties or characteristics of a nutritional powder.

### Loose Bulk Density Test

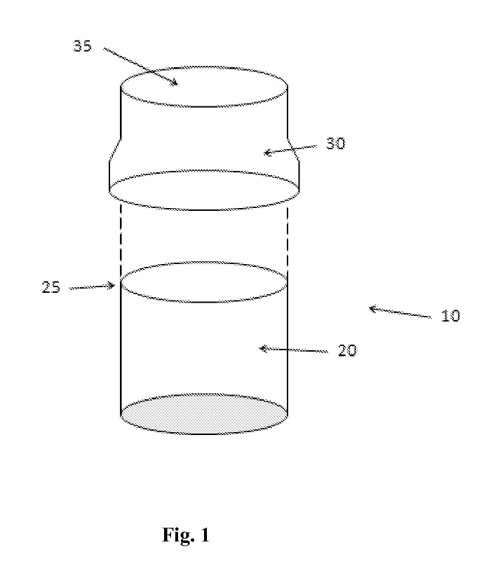

Generally, loose bulk density of a powder can be measured by any of several industry standard methods, including, but not limited to, ASTM D6683-14, “Standard Test Method for Measuring Bulk Density Values of Powders and Other Bulk Solids as a Function of Compressive Stress,” and GEA Niro Analytical Method A 2 A, “Powder Bulk Density.” For example, the test method can be adapted to measure the loose bulk density of a powder using the same equipment employed in the Vibrated Bulk Density Test below. More specifically, the test method uses a test cylinder having a top portion and bottom portion capable of being separated. One exemplary test cylinder is a Plexiglas® bulk density test cylinder 10, illustrated in FIG. 1, which comprises a calibrated bottom portion 20 and a top portion 30. Preferably, the volume of the bottom portion 20 of the test cylinder 10 is calibrated and permanently labeled thereon. The calibration may be in any appropriate volumetric measurement, e.g., cubic centimeters (“cc”) or milliliters (“mL”).

The bottom portion 20 of the test cylinder 10 is weighed to determine the tare weight. The top portion 30 of the test cylinder is then placed on top of the bottom portion 20 of the test cylinder. The test cylinder 10 is then filled to near overflowing with the test powder (e.g., through the opening 35 at the top of the top portion 30). Care should be taken to avoid compressing the powder as the cylinder is filled. A powder funnel may be used to simplify this task. Visible air gaps or unfilled portions of the cylinder should be avoided.

Any excess powder is removed and the top of the cylinder is removed. For example, when using the test cylinder 10 illustrated in FIG. 1, the top section 30 of the test cylinder 10 is carefully removed over an appropriate waste receptacle. Using a spatula, the excess powder sample above the mouth 25 of the bottom section 20 of the test cylinder is struck off such that the powder contained in the bottom section 20 is smooth and flush with the mouth 25. Using a dry cloth, any powder clinging to the outside of the bottom section 20 is removed.

The bottom section of the test cylinder with the loose powder sample is then weighed to determine the gross weight. The loose bulk density of the powder is calculated as follows:

$$\frac{[ Gross weight ( g ) ] - [ Tare weight ( g ) ]}{[ Calibrated test cylinder volume ( cc ) ]} = Loose Bulk Density ( g \text{/} cc )$$

### Vibrated Bulk Density Test

Generally, the following test method is used to measure the bulk density of a powder that has been compressed by vibration in a reproducible manner. More specifically, the test method uses a test cylinder having a top portion and bottom portion capable of being separated. One exemplary test cylinder is a Plexiglas® bulk density test cylinder 10, illustrated in FIG. 1, which comprises a calibrated bottom portion 20 and a top portion 30. Preferably, the volume of the bottom portion 20 of the test cylinder 10 is calibrated and permanently labeled thereon. The calibration may be in any appropriate volumetric measurement, e.g., cubic centimeters (“cc”) or milliliters (“mL”).

The bottom portion 20 of the test cylinder 10 is weighed to determine the tare weight. The top portion 30 of the test cylinder is then placed on top of the bottom portion 20 of the test cylinder. The test cylinder 10 is then filled to near overflowing with the test powder (e.g., through the opening 35 at the top of the top portion 30). Care should be taken to avoid compressing the powder as the cylinder is filled. A powder funnel may be used to simplify this task. Visible air gaps or unfilled portions of the cylinder should be avoided.

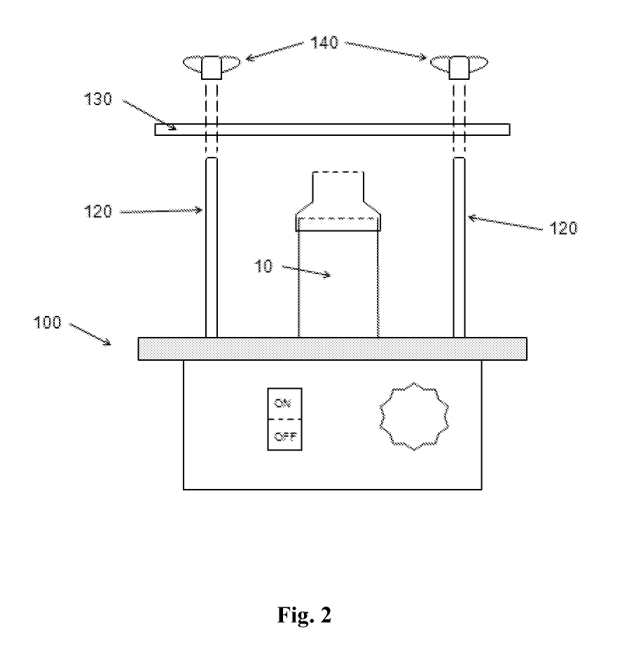

The test cylinder 10 is placed on or in a vibration apparatus (e.g., a modified Syntron® J-1A portable jogger 100, as illustrated in FIG. 2). The test cylinder 10 is secured to the vibration apparatus by being placed between the clamping rods 120 and clamped in place with the clamping strap 130 and wing nuts 140. The modified vibration table 100 is set to a predetermined amplitude (e.g., amplitude=5, frequency=60 Hz), and the test cylinder is vibrated for a 60-second vibration cycle.

When the vibration cycle is complete, the test cylinder is unclamped and removed from the modified vibration table 100. Any excess powder is removed and the top of the cylinder is removed. For example, when using the test cylinder 10 illustrated in FIG. 1, the top section 30 of the test cylinder 10 is carefully removed over an appropriate waste receptacle. Using a spatula, the excess powder sample above the mouth 25 of the bottom section 20 of the test cylinder is struck off such that the powder contained in the bottom section 20 is smooth and flush with the mouth 25. Using a dry cloth, any powder clinging to the outside of the bottom section 20 is removed.

The bottom section of the test cylinder with the vibrated powder sample is then weighed to determine the gross weight. The vibrated bulk density of the powder is calculated as follows:

$$\frac{[ Gross weight ( g ) ] - [ Tare weight ( g ) ]}{[ Calibrated test cylinder volume ( cc ) ]} = Vibrated Bulk Density ( g \text{/} cc )$$

### Mercury Porosimetry Test

Mercury porosimetry is used to measure the envelope powder volume, the powder porosity, and the open pore volume of the particles of the nutritional powder. For this method, a sample of the powder to be tested is placed in a sample cup that is capable of being sealed and placed under vacuum. The sample cup is then evacuated under a vacuum to remove adsorbed gases and moisture from the sample. Liquid mercury is then fed into the sample cup through a capillary. The mercury is then slowly pressurized through the capillary to compress the powder and force the mercury into interstitial void volume and the open pores of the sample powder particles. The volume of mercury being forced into the sample is monitored as a function of pressure, because the mercury is forced into increasingly smaller voids and pores as the pressure increases. The volume of mercury released from the pores as the pressure is decreased may also be determined. Data from a pressure-volume curve can be used to quantify the envelope powder volume, the interstitial void volume, and the open pore volume of the particles, as well as the pore size distribution for the powder particles. The powder porosity is calculated as:

$$\frac{[ Interstitial void volume ] + [ Open pore volume ]}{Envelope powder volume} \times 100 = \% powder porosity$$

### Particle Size and Particle Size Distribution by Laser Diffraction

Laser diffraction is used to measure the particle size and particle size distribution for a powder. The powder is dispersed into an air stream and passed through a laser beam. The particles diffract the photons of the laser at different angles, depending on the size of the particle. A detector with semicircular ring elements detects the diffracted photons. The intensity of the detected photons and the angle of detection are used to calculate the number, area, and volume-weighted particle size in the sample, and a particle size distribution can be determined. From this distribution, an average particle size, based on the number, area, or volume of particles, can also be calculated.

### Nutritional Powder Reconstitution Test

Generally, a nutritional powder reconstitution test can be used to evaluate how thoroughly the nutritional powder is reconstituted under the operating conditions of a beverage production machine, and to determine a corresponding reconstitution rate.

According to this test, multiple same size portions (e.g., triplicate portions of 2-5 g samples) are taken from the same batch of the nutritional powder to be tested. These portions are weighed both before and after drying by conventional drying techniques (e.g., convection or IR) to determine the initial moisture content of each portion (i.e., the weight lost to drying). The average initial moisture content (by weight) is then determined by averaging the results from the multiple portions.

Preweighed portions of each test sample of the nutritional powder are enclosed in resealable nutritional powder pods for the reconstitution testing. Example amounts of the test samples of the nutritional powder range from 2-150 grams.

The test system may be a working beverage production machine, or a model system configured to simulate a beverage production machine and operating under specified conditions. The test system is configured to accommodate and operate under the operating conditions of a beverage product machine, as follows. The pressure within the pod, as well as the temperature of the water that contacts the nutritional powder and the amount of water flowing through the pod are controlled and measurable.

For the reconstitution test, the pod containing the test sample of the nutritional powder is inserted into the test system, and the system is set to deliver a certain amount of water (e.g., about 25-500 mL) at a certain temperature (e.g., in the range of 5-50° C.) under a certain pressure (e.g., 0.5-15 bar, or approximately 7-217 psia) into and through the pod. Under this test, the ratio of powder weight (grams) to water weight (grams) (where the density of water is taken to be 1 g/mL) is lower than 1:1 (e.g., 1:1.1, 1:1.2, 1:1.3, 1:2, 1:3, 1:5, etc.). In other words, relatively less powder (in grams) is used as compared to the amount (in grams) of water. A sufficiently large collection bottle is placed under the dispenser of the test system to receive the homogeneous liquid product output. The test system is started, and the homogeneous liquid product is collected in the collection bottle.

### Reconstitution Time

During the nutritional powder reconstitution test, described above, the reconstitution time is determined by measuring the time that elapses from the initiation time until the reconstituted product is observed to be fully delivered to the collection bottle.

### Rate of Reconstitution

The rate of reconstitution is determined using the general test method and system for the Nutritional Powder Reconstitution Test described above, except that the reconstituted liquid product is collected over 5-second intervals in sequentially-numbered collection vessels. The mass of collected powder in the reconstituted liquid product in each collection vessel is measured using any standard drying technique (e.g., forced air oven, infrared heating, microwave drying, etc.) to remove the water from the collected reconstituted liquid product. The rate of reconstitution is then determined by dividing the weight of total reconstituted solids, i.e., the mass of collected powder (milligram) by the original mass of nutritional powder in the pod (gram) and the collection time interval (seconds), thereby resulting in a “milligram/gram-second” value.

### Reconstitution Yield

The reconstitution yield is determined using the general test method and system described for the Nutritional Powder Reconstitution Test described above. The Nutritional Powder Reconstitution test is run, and the residual powder remaining in the pod is measured. A known amount of water is dispensed into the pod to rinse out the residual powder, and this rinsing water with the residual powder is emptied into a collection vessel. The total solids in the rinsing water is measured using any standard drying technique (e.g., via a forced air oven or microwave drying technique) to remove the water from the rinsings. The total solids in the rinsing water is determined and divided by the percentage of dry-weight solids in the original powder. Finally, the reconstitution yield, which relates to the mass of reconstituted powder in the final liquid product, is determined by subtracting the ratio of the mass of powder remaining in the pod to mass of powder originally in the pod from 1. The reconstituted yield can be reported in the units of “milligram/milligram” (mg/mg) or converted to a percentage (e.g., milligram/milligram×100%).

### EXAMPLES

The following paragraphs describe and demonstrate exemplary embodiments of the nutritional powders described herein. The exemplary embodiments are provided solely for the purpose of illustration and are not to be construed as limitations of the present disclosure, as many variations thereof are possible without departing from the spirit and scope of the present disclosure. The exemplary nutritional powders may be prepared in accordance with the methods described herein.

Example 1A illustrates an exemplary nutritional powder (Table 3) that is formulated as an infant formula. All ingredient amounts in Table 3 are listed as pounds (lb) per 1,000 lb batch of nutritional powder.

TABLE 3

| Ingredients | Example 1A |
|---|---|
| Lactose | 388.31 |
| Non-Fat Dry Milk | 203.16 |
| High Oleic Safflower Oil | 115.89 |
| Soy Oil | 88.04 |
| Coconut Oil | 81.09 |
| Galactooligosaccharides | 66.87 |
| Whey Protein Concentrate | 50.00 |
| Potassium Citrate | 9.16 |
| Lecithin | 5.00 |
| Calcium Carbonate | 4.03 |
| Arachidonic Acid | 3.69 |
| Potassium Chloride | 1.25 |
| Docosahexaenoic Acid | 1.11 |
| Magnesium Chloride | 1.03 |
| Sodium Chloride | 0.59 |
| Choline Chloride | 0.43 |
| Vitamin ADEK | 0.39 |
| Ascorbyl Palmitate | 0.37 |
| Mixed Carotenoid Premix | 0.35 |
| Mixed Tocopherols | 0.16 |
| Ascorbic Acid | 1.27 |
| Riboflavin | 0.003 |
| L-Carnitine | 0.026 |
| Vitamin/Mineral Premix | 1.11 |
| Ferrous Sulfate | 0.45 |
| Nucleotide/Choline | 2.33 |

Example 1B illustrates an exemplary nutritional powder (Table 4) that is formulated as a soy-protein containing infant formula. All ingredient amounts in Table 4 are listed as kilogram (kg) per 1,000 kg batch of nutritional powder.

TABLE 4

| | |
|---|---|
| | Example 1B |
| Ingredient | (Quantity (kg) per 1,000 kg batch) |

| Corn Syrup | 504.1 | |
|---|---|---|
| Soy Protein Isolate (5% DH) | 144.8 | |
| Sunflower Oil | 112.5 | |
| Sucrose | 98.3 | |
| Soy Oil | 83.9 | |
| Coconut Oil | 75.6 | |
| Fructooligosaccharides | 17 | |
| Potassium Citrate | 16.5 | |
| Calcium Phosphate | 16.4 | |
| Sodium Chloride | 3.8 | |
| Arachidonic Acid Oil | 3 | |
| Magnesium Chloride | 2.8 | |
| L-Methionine | 1.7 | |
| Ascorbic Acid | 1.1 | |
| Docosahexaenoic Acid Oil | 1.1 | |
| Lutein | 945.0 | mg |
| Choline Chloride | 507.7 | g |
| Taurine | 457.5 | g |
| Inositol | 353.0 | g |
| Ascorbyl Palmitate | 347.5 | g |
| Ferrous Sulfate | 319.2 | g |
| Mixed Tocopherols | 157.2 | g |
| L-Carnitine | 112.7 | g |
| Niacinamide | 97.9 | g |
| D-Alpha-Tocopheryl Acetate | 78.8 | g |
| Calcium D-Pantothenate | 58.7 | g |
| Zinc | 56.0 | g |
| Iron | 16.9 | g |
| Thiamine | 15.2 | g |
| Vitamin A Palmitate | 14.8 | g |
| Copper | 7.2 | g |
| Riboflavin | 6.7 | g |
| Pyridoxine Hydrochloride | 6.1 | g |
| Folic Acid | 2.1 | g |
| Potassium Iodide | 1.1 | g |
| Phylloquinone | 857.1 | mg |
| Vitamin D3 | 47 | mg |
| Lycopene | 980.0 | mg |
| Biotin | 592.5 | mg |
| Beta-Carotene | 215.6 | mg |
| Selenium | 147.0 | mg |
| Cyanocobalamin | 71.3 | mg |

Example 2 illustrates an exemplary nutritional powder (Table 5) that is formulated as a pediatric formula. All ingredient amounts in Table 5 are listed as kilogram (kg) per 1,000 kg batch of nutritional powder.

TABLE 5

| | Example 2 | |
|---|---|---|
| Ingredients | (Quantity (kg) per 1,000 kg batch) | |
| Maltodextrin | 300.0 | |
| Sucrose | 288.0 | |
| Milk Protein Concentrate (80%) | 121.1 | |
| Soy Oil | 82.0 | |
| High Oleic Sunflower Oil | 69.5 | |
| Whey Protein Concentrate | 27.9 | |
| MCT Oil | 26.7 | |
| Soy Protein Isolate | 24.4 | |
| Fructooligosaccharides | 22.9 | |
| Potassium Citrate | 7.1 | |
| Flavor | 6.7 | |
| Magnesium Phosphate Dibasic | 5.7 | |
| Potassium Chloride | 4.3 | |
| Sodium Chloride | 3.7 | |
| Tricalcium Phosphate | 3.2 | |
| Vitamin/Mineral Premix | 2.5 | |
| Docosahexaenoic Acid | 2.0 | |
| Choline Chloride | 1.7 | |
| Potassium Phosphate Monobasic | 1.5 | |
| Calcium Carbonate | 1.4 | |
| Potassium Phosphate Dibasic | 1.2 | |
| Ascorbic Acid | 871.7 | grams |
| Arachidonic Acid | 645.0 | grams |
| Ascorbyl Palmitate | 502.1 | grams |
| Vitamin ADEK Premix | 176.5 | grams |
| Lactobacillus Acidophilus | 100.0 | grams |
| Tocopherol Antioxidant | 83.7 | grams |
| dl-Alpha Tocopheryl Acetate | 49.5 | grams |
| Bifidobacterium Lactis | 35.0 | grams |
| Vitamin A Palmitate | 1.2 | grams |
| Potassium Iodide | 89.2 | milligrams |

| | |
|---|---|
| Sodium Citrate | As Needed |
| Magnesium Chloride | As Needed |
| Citric Acid (processing aid) | As Needed |
| Potassium Hydroxide (processing | As Needed |

Example 3 illustrates an exemplary nutritional powder (Table 6) that is formulated as an adult nutritional product. All ingredient amounts in Table 6 are listed as kilogram (kg) per 1,000 kg batch of nutritional powder.

TABLE 6

| | Example 3 | |
|---|---|---|
| Ingredients | (Quantity (kg) per 1,000 kg batch) | |
| Maltodextrin | 268.7 | |
| Corn Syrup Solids | 192.7 | |
| Milk Protein Concentrate (80%) | 133 | |
| Sucrose | 112.4 | |
| High Oleic Sunflower Oil | 85.3 | |
| Soy Oil | 38.5 | |
| Soy Protein Isolate | 54.7 | |
| Fructooligosaccharides | 21.9 | |
| Inulin | 21.9 | |
| Canola Oil | 13.8 | |
| Sodium Citrate | 12.8 | |
| Potassium Citrate | 11.7 | |
| Flavor | 7.3 | |
| Magnesium Chloride | 6.3 | |
| Potassium Chloride | 4.2 | |
| Tricalcium Phosphate | 3.5 | |
| Choline Chloride | 1.7 | |
| Ascorbic Acid | 880.0 | grams |
| Calcium Carbonate | 553.0 | grams |
| Water Soluble Vitamin Premix | 485.0 | grams |
| Ultra Trace Mineral/Trace Mineral | 430.0 | grams |
| Ascorbyl Palmitate | 164.6 | grams |
| Vitamin AEDK Premix | 146.7 | grams |
| Tocopherol Antioxidant | 82.3 | grams |
| dl-Alpha Tocopheryl Acetate | 44.7 | grams |
| Beta Carotene (30%) | 5.5 | grams |
| Manganese Sulfate | 3.7 | grams |
| Thiamin Hydrochloride | 2.5 | grams |
| Riboflavin | 1.5 | grams |
| Vitamin A Palmitate | 1.2 | grams |
| Potassium Iodide | 913.3 | milligrams |

| | |
|---|---|
| Magnesium Sulfate | As Needed |
| Copper Sulfate | As Needed |
| Citric Acid (processing aid) | As Needed |
| Potassium Hydroxide (processing | As Needed |

Examples 4-39 illustrate the physical properties of various nutritional powders of the present invention. The nutritional powders were prepared according to the methods described previously. The nutritional powders included powders prepared by spray-dried (encoded “SD” in the table), dry blended (encoded “DB” in the table), and extruded (encoded “EX” in the table) manufacturing methods. The nutritional powders included infant, toddler, and adult formulations. Examples 4-15, 21-22, and 33 were nutritional powders with formulations similar to the formulation given in Table 3 above. Examples 16 and 36 were nutritional powders with formulations similar to the formulation given in Table 4 above. Examples 25-26 and 38 were nutritional powders with formulations similar to the formulation given in Table 5 above. Examples 27-28, 31, and 39 were nutritional powders with formulations similar to the formulation given in Table 6 above. Examples 8 and 9 were the same products produced in the same manner, and Examples 10, 11, and 14 were also the same products produced in the same manner.

These exemplary nutritional powders were tested to determine the loose bulk density and vibrated bulk density of each. These results are shown in Table 7.

TABLE 7

| | Sample | Loose Bulk | Vibrated Bulk |
|---|---|---|---|
| Example | Code | Density (g/cc) | Density (g/cc) |
| Example 4 | SD-1A | 0.46 | 0.57 |
| Example 5 | SD-2A | 0.43 | 0.56 |
| Example 6 | SD-7A | 0.42 | 0.54 |
| Example 7 | SD-8D | 0.42 | 0.55 |
| Example 8 | SD-1D | 0.50 | 0.62 |
| Example 9 | SD-2D | 0.50 | 0.63 |
| Example 10 | SD-3D | 0.49 | 0.63 |
| Example 11 | SD-4D | 0.52 | 0.62 |
| Example 12 | SD-8A | 0.41 | 0.46 |
| Example 13 | SD-9A | 0.42 | 0.56 |
| Example 14 | SD-1C | 0.48 | 0.58 |
| Example 15 | SD-2C | 0.47 | 0.58 |
| Example 16 | SD-3C | 0.48 | 0.61 |
| Example 17 | SD-3A | 0.46 | 0.57 |
| Example 18 | SD-4A | 0.42 | 0.54 |
| Example 19 | SD-6A | 0.43 | 0.56 |
| Example 20 | DB-1B | 0.48 | 0.63 |
| Example 21 | DB-2B | 0.44 | 0.59 |
| Example 23 | DB-5A | 0.44 | 0.55 |
| Example 24 | DB-4C | 0.45 | 0.55 |
| Example 25 | DB-7C | 0.51 | 0.67 |
| Example 26 | DB-5D | 0.40 | 0.57 |
| Example 27 | DB-8C | 0.54 | 0.66 |
| Example 28 | DB-6D | 0.48 | 0.61 |
| Example 29 | DB-5C | 0.42 | 0.52 |
| Example 30 | DB-6C | 0.42 | 0.60 |
| Example 31 | DB-7D | 0.52 | 0.65 |
| Example 32 | DB-9C | 0.60 | 0.74 |
| Example 33 | EX-3B | 0.55 | 0.65 |
| Example 34 | EX-4B | 0.40 | 0.51 |
| Example 35 | EX-5B | 0.28 | 0.35 |
| Example 36 | EX-6B | 0.41 | 0.52 |
| Example 37 | EX-7B | 0.42 | 0.54 |
| Example 38 | EX-8B | 0.39 | 0.52 |
| Example 39 | EX-9B | 0.60 | 0.73 |

The nutritional powders of Examples 4-39 had loose bulk densities from about 0.28 g/cc to about 0.60 g/cc, and vibrated bulk densities from about 0.35 g/cc to about 0.74 g/cc. The spray dried nutritional powders (Examples 4-19) had loose bulk densities from about 0.41 g/cc to about 0.52 g/cc (average loose density of about 0.46 g/cc), and vibrated bulk densities from about 0.46 g/cc to about 0.57 g/cc (average vibrated density of about 0.57 g/cc). The nutritional powders that were dry blended (Examples 20-32) had loose bulk densities from about 0.40 g/cc to about 0.60 g/cc (average loose density of about 0.47 g/cc), and vibrated bulk densities from about 0.52 g/cc to about 0.74 g/cc (average vibrated density of about 0.61 g/cc). The extruded nutritional powders (33-39) had the broadest density range, with loose bulk densities from about 0.28 g/cc to about 0.60 g/cc (average loose density of about 0.43 g/cc) and vibrated bulk densities from about 0.35 g/cc to about 0.73 g/cc (average vibrated density of about 0.54 g/cc).

The porosity of some of the nutritional powders of Examples 4-39 was measured using mercury porosimetry, as described previously. The results are given in Table 8.

TABLE 8

| | Sample | |
|---|---|---|
| Example | Code | Porosity (%) |
| Example 4 | SD-1A | 57 |
| Example 6 | SD-7A | 61 |
| Example 7 | SD-8D | 61 |
| Example 8 | SD-1D | 56 |
| Example 9 | SD-2D | 57 |
| Example 14 | SD-1C | 59 |
| Example 16 | SD-3C | 54 |
| Example 19 | SD-6A | 56 |
| Example 20 | DB-1B | 58 |
| Example 23 | DB-5A | 57 |
| Example 24 | DB-4C | 57 |
| Example 26 | DB-5D | 63 |
| Example 27 | DB-8C | 54 |
| Example 32 | DB-9C | 52 |
| Example 33 | EX-3B | 37 |
| Example 35 | EX-5B | 67 |
| Example 36 | EX-6B | 60 |

The exemplary nutritional powders of Examples 4-39 had porosities from about 37% to about 67% (average porosity of about 57%). The spray dried nutritional powders had porosities from about 54% to about 61% (average porosity of about 58%). The nutritional powders that were dry blended had porosities from about 52% to about 63% (average porosity of about 57%). The extruded nutritional powders had the broadest porosity range, with porosities from about 37% to about 67% (average porosity of about 55%).

The mean particle size and particle size distribution of the nutritional powders of Examples 4-39 was measured using laser diffraction, as described previously. The particle size distribution reports the range of particles sizes from the 10th to the 90th percentile. The results are given in Table 9.

TABLE 9

| | | | Particle Size | |
|---|---|---|---|---|
| | | | Distribution (μm) | |
| | Sample | Mean Particle | 10^{th} | 90^{th} |
| Example | Code | Size (μm) | percentile | percentile |
| Example 4 | SD-1A | 141 | 31 | 275 |
| Example 5 | SD-2A | 159 | 52 | 287 |
| Example 6 | SD-7A | 145 | 46 | 254 |
| Example 7 | SD-8D | 140 | 47 | 247 |
| Example 8 | SD-1D | 181 | 56 | 330 |
| Example 9 | SD-2D | 205 | 62 | 378 |
| Example 10 | SD-3D | 191 | 58 | 356 |
| Example 11 | SD-4D | 181 | 57 | 378 |
| Example 12 | SD-8A | 156 | 44 | 225 |
| Example 13 | SD-9A | 128 | 46 | 282 |
| Example 14 | SD-1C | 113 | 39 | 201 |
| Example 15 | SD-2C | 125 | 31 | 231 |
| Example 16 | SD-3C | 140 | 31 | 272 |
| Example 17 | SD-3A | 146 | 44 | 277 |
| Example 18 | SD-4A | 130 | 30 | 247 |
| Example 19 | SD-6A | 121 | 21 | 240 |
| Example 20 | DB-1B | 99 | 18 | 195 |
| Example 21 | DB-2B | 113 | 26 | 221 |
| Example 23 | DB-5A | 147 | 38 | 288 |
| Example 24 | DB-4C | 101 | 22 | 203 |
| Example 25 | DB-7C | 117 | 22 | 240 |
| Example 26 | DB-5D | 104 | 13 | 221 |
| Example 27 | DB-8C | 133 | 29 | 247 |
| Example 28 | DB-6D | 123 | 37 | 236 |
| Example 29 | DB-5C | 137 | 29 | 263 |
| Example 30 | DB-6C | 146 | 17 | 257 |
| Example 31 | DB-7D | 105 | 21 | 208 |
| Example 32 | DB-9C | 148 | 19 | 308 |
| Example 33 | EX-3B | 334 | 50 | 599 |
| Example 34 | EX-4B | 273 | 61 | 541 |
| Example 35 | EX-5B | 164 | 36 | 348 |
| Example 36 | EX-6B | 173 | 46 | 339 |
| Example 37 | EX-7B | 179 | 30 | 391 |
| Example 38 | EX-8B | 176 | 39 | 375 |
| Example 39 | EX-9B | 379 | 61 | 111 |

The exemplary nutritional powders of Examples 4-39 had mean particle sizes from about 99 μm to about 379 μm, with an average particle size distribution ranging from about 37 μm to about 307 μm. The spray dried nutritional powders had mean particle sizes from about 113 μm to about 205 μm, with an average particle size distribution ranging from about 43 μm to about 280 μm. The nutritional powders that were dry blended generally had the smallest particles, with mean particle sizes from about 99 μm to about 148 μm, and an average particle size distribution ranging from about 24 μm to about 241 μm. The extruded nutritional powders generally had the largest particles, with mean particle sizes from about 164 μm to about 379 μm, with an average particle size distribution ranging from about 46 μm to about 482 μm.

The reconstitution time and reconstitution yield of some of the nutritional powders of Examples 4-39 was measured as described previously. The results are given in Table 10.

TABLE 10

| | Sample | Reconstitution | Reconstitution |
|---|---|---|---|
| Example | Code | time (sec) | Yield (%) |
| Example 4 | SD-1A | 40 | 99.3 |
| Example 5 | SD-2A | 40 | 98.8 |
| Example 6 | SD-7A | 45 | 99.7 |
| Example 7 | SD-8D | 40 | 92.3 |
| Example 8 | SD-1D | 40 | 91.1 |
| Example 9 | SD-2D | 40 | 99.2 |
| Example 10 | SD-3D | 30 | 98.8 |
| Example 11 | SD-4D | 25 | 94.1 |
| Example 12 | SD-8A | 45 | 99.3 |
| Example 13 | SD-9A | 40 | 91.8 |
| Example 14 | SD-1C | 35 | 91.5 |
| Example 15 | SD-2C | 40 | 94.4 |
| Example 16 | SD-3C | 40 | 98.9 |
| Example 17 | SD-3A | 40 | 98.8 |
| Example 18 | SD-4A | 25 | 82.8 |
| Example 19 | SD-6A | 40 | 99.0 |
| Example 20 | DB-1B | 35 | 98.9 |
| Example 21 | DB-2B | 30 | 96.0 |
| Example 25 | DB-7C | 25 | 86.3 |
| Example 26 | DB-5D | 25 | 95.8 |
| Example 28 | DB-6D | 25 | 95.3 |
| Example 32 | DB-9C | 40 | 98.5 |
| Example 34 | EX-4B | 45 | 99.3 |
| Example 35 | EX-5B | 40 | 98.7 |
| Example 36 | EX-6B | 40 | 98.9 |
| Example 37 | EX-7B | 45 | 99.0 |

The reconstitution properties of all tested powders were very good. The exemplary nutritional powders of Examples 4-37 had reconstitution times ranging from about 25 sec to about 45 sec, with an average reconstitution time of about 36 sec. The reconstitution yield of all tested nutritional powders ranged from about 82.8% to about 99.7%, with an average reconstitution yield of about 96.0%. The spray dried nutritional powders had reconstitution times ranging from about 25 sec to about 45 sec, with an average reconstitution time of about 38 sec. The reconstitution yield of the spray dried nutritional powders ranged from about 82.8% to about 99.7%, with an average reconstitution yield of about 95.6%. The nutritional powders that were dry blended had reconstitution times ranging from about 25 sec to about 40 sec, with an average reconstitution time of about 29 sec. The reconstitution yield of the dry blended nutritional powders ranged from about 86.3% to about 98.9%, with an average reconstitution yield of about 95.1%. The extruded nutritional powders generally had the slowest reconstitution times, with reconstitution times ranging from about 40 sec to about 45 sec, with an average reconstitution time of about 43 sec. The reconstitution yield of the extruded nutritional powders was excellent, ranging from about 98.7% to about 99.3%, with an average reconstitution yield of about 99.0%.

The rate of reconstitution of some of the nutritional powders of Examples 4-39 was measured as described previously. To determine the reconstitution rate, aliquots of the reconstituted liquid were collected in 5-second intervals. The results are given in Table 11.

TABLE 11

| | | Reconstitution Rate (mg/g-sec) | | | | | | | | |
|---|---|---|---|---|---|---|---|---|---|---|
| | Sample | 0-5 | 5-10 | 10-15 | 15-20 | 20-25 | 25-30 | 30-35 | 35-40 | 40-45 |
| Example | Code | sec | sec | sec | sec | sec | sec | sec | sec | sec |
| Example 4 | SD-1A | 18.4 | 4.0 | 0.6 | 0.6 | 0.5 | 0.4 | 0.4 | 0.1 | — |
| Example 5 | SD-2A | 16.5 | 4.6 | 1.1 | 1.0 | 1.3 | 1.1 | 0.6 | 0.1 | — |
| Example 6 | SD-7A | 16.6 | 2.9 | 0.7 | 1.0 | 0.9 | 1.0 | 0.9 | 0.3 | 0.1 |
| Example 7 | SD-8D | 19.7 | 4.9 | 1.1 | 0.8 | 1.3 | 1.1 | 0.9 | 0.2 | — |
| Example 8 | SD-1D | 18.1 | 1.8 | 1.3 | 0.8 | 1.0 | 1.1 | 0.8 | 0.3 | — |
| Example 9 | SD-2D | 19.6 | 3.7 | 0.6 | 0.4 | 0.5 | 0.5 | 0.4 | 0.1 | — |
| Example 10 | SD-3D | 17.2 | 5.3 | 3.1 | 1.8 | 1.8 | 0.7 | — | — | — |
| Example 11 | SD-4D | 15.2 | 3.5 | 8.0 | 2.6 | 0.3 | — | — | — | — |
| Example 12 | SD-8A | 17.9 | 3.1 | 0.8 | 1.0 | 0.9 | 0.8 | 0.7 | 0.2 | 0.1 |
| Example 13 | SD-9A | 18.2 | 5.9 | 1.5 | 0.8 | 1.1 | 1.1 | 1.1 | 0.4 | — |
| Example 14 | SD-1C | 16.5 | 5.1 | 3.0 | 3.6 | 1.4 | 0.2 | 0.1 | — | — |
| Example 15 | SD-2C | 18.8 | 5.3 | 1.6 | 0.7 | 1.0 | 1.1 | 0.7 | 0.1 | — |
| Example 16 | SD-3C | 15.5 | 3.6 | 1.3 | 1.2 | 1.4 | 1.3 | 1.1 | 0.3 | — |
| Example 17 | SD-3A | 14.8 | 5.3 | 1.3 | 0.8 | 1.0 | 1.1 | 0.9 | 0.4 | — |
| Example 18 | SD-4A | 8.9 | 3.0 | 9.0 | 1.0 | 0.2 | — | — | — | — |
| Example 19 | SD-6A | 16.8 | 3.2 | 1.5 | 1.2 | 1.2 | 1.4 | 1.1 | 0.4 | — |
| Example 20 | DB-1B | 19.4 | 5.0 | 2.3 | 1.3 | 0.9 | 0.9 | 0.3 | — | — |
| Example 21 | DB-2B | 13.7 | 5.5 | 3.2 | 5.1 | 3.3 | 0.7 | — | — | — |
| Example 25 | DB-7C | 15.3 | 10.2 | 6.5 | 8.7 | 0.3 | — | — | — | — |
| Example 26 | DB-5D | 18.9 | 16.0 | 2.1 | 7.5 | 0.3 | — | — | — | — |
| Example 28 | DB-6D | 23.9 | 12.0 | 1.7 | 9.1 | 1.7 | — | — | — | — |
| Example 32 | DB-9C | 19.3 | 5.5 | 4.4 | 0.6 | 1.7 | 1.7 | 0.9 | 0.1 | — |
| Example 34 | EX-4B | 13.3 | 8.9 | 0.3 | 1.0 | 0.7 | 0.8 | 0.5 | 0.1 | 0.1 |
| Example 35 | EX-5B | 8.6 | 5.1 | 4.6 | 3.2 | 2.0 | 2.2 | 0.6 | 0.1 | — |
| Example 36 | EX-6B | 16.0 | 3.2 | 1.7 | 1.2 | 1.1 | 1.4 | 1.1 | 0.2 | — |
| Example 37 | EX-7B | 12.0 | 7.5 | 3.8 | 0.3 | 0.8 | 1.0 | 1.2 | 0.7 | 0.1 |

The reconstitution rate for all powders was typically greatest during the first 5 to 10 seconds of testing, then dropped during the following test intervals. The exemplary nutritional powders of Examples 4-37 had reconstitution rates in the first 5 seconds ranging from about 8 mg/g-sec to about 24 mg/g-sec, with an average reconstitution rate of about 16 mg/g-sec. The reconstitution rate from 5 to 10 seconds for all tested nutritional powders ranged from about 3 mg/g-sec to about 16 mg/g-sec, with an average reconstitution rate of about 5 mg/g-sec. The reconstitution rate from 10 to 15 seconds for all tested nutritional powders ranged from about 0.3 mg/g-sec to about 8 mg/g-sec, with an average reconstitution rate of about 3 mg/g-sec. The reconstitution rate from 15 to 20 seconds for all tested nutritional powders ranged from about 0.3 mg/g-sec to about 9 mg/g-sec, with an average reconstitution rate of about 2 mg/g-sec. After 20 seconds, the reconstitution rate for all tested nutritional powders was typically less than about 2 mg/g-sec. The spray dried nutritional powders had reconstitution rates in the first 5 seconds ranging from about 9 mg/g-sec to about 20 mg/g-sec, with an average reconstitution rate of about 17 mg/g-sec. The reconstitution rate from 5 to 10 seconds for the spray dried nutritional powders ranged from about 3 mg/g-sec to about 6 mg/g-sec, with an average reconstitution rate of about 4 mg/g-sec. The reconstitution rate from 10 to 15 seconds for the spray dried nutritional powders ranged from about 0.6 mg/g-sec to about 9 mg/g-sec, with an average reconstitution rate of about 2 mg/g-sec. The reconstitution rate from 15 to 20 seconds for the spray dried nutritional powders ranged from about 0.4 mg/g-sec to about 3.6 mg/g-sec, with an average reconstitution rate of about 1.2 mg/g-sec. After 20 seconds, the reconstitution rate for the spray dried nutritional powders was typically less than about 2 mg/g-sec. The nutritional powders that were dry blended had reconstitution rates in the first 5 seconds ranging from about 6 mg/g-sec to about 24 mg/g-sec, with an average reconstitution rate of about 17 mg/g-sec. The reconstitution rate from 5 to 10 seconds for the dry blended nutritional powders ranged from about 5 mg/g-sec to about 16 mg/g-sec, with an average reconstitution rate of about 3 mg/g-sec. The reconstitution rate from 10 to 15 seconds for the dry blended nutritional powders ranged from about 2 mg/g-sec to about 6 mg/g-sec, with an average reconstitution rate of about 3 mg/g-sec. The reconstitution rate from 15 to 20 seconds for the dry blended nutritional powders ranged from about 0.6 mg/g-sec to about 9 mg/g-sec, with an average reconstitution rate of about 5 mg/g-sec. After 20 seconds, the reconstitution rate for the dry blended nutritional powders was typically less than about 3.5 mg/g-sec. The extruded nutritional powders had reconstitution rates in the first 5 seconds ranging from about 8 mg/g-sec to about 16 mg/g-sec, with an average reconstitution rate of about 12 mg/g-sec. The reconstitution rate from 5 to 10 seconds for the extruded nutritional powders ranged from about 3 mg/g-sec to about 9 mg/g-sec, with an average reconstitution rate of about 6 mg/g-sec. The reconstitution rate from 10 to 15 seconds for the extruded nutritional powders ranged from about 0.3 mg/g-sec to about 5 mg/g-sec, with an average reconstitution rate of about 3 mg/g-sec. The reconstitution rate from 15 to 30 seconds for the extruded nutritional powders ranged from about 0.3 mg/g-sec to about 3 mg/g-sec, with an average reconstitution rate of about 1 mg/g-sec. After 20 seconds, the reconstitution rate for the extruded nutritional powders was typically less than about 2 mg/g-sec.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative compositions, formulations, and methods, and illustrative examples shown and described. Accordingly, departures may be made from such details without departing from the spirit or scope of the applicant's general disclosure herein.

To the extent that the terms “includes,” “including,” “contains,” or “containing” are used herein, they are intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Also, to the extent that the terms “in” or “into” are used herein, it is intended to additionally mean “on” or “onto.”

All percentages, parts, and ratios as used herein are by weight of the total product, unless specified otherwise. All such weights as they pertain to listed ingredients are based on the active ingredients and, therefore, do not include solvents or by-products that may be included in commercially available materials, unless specified otherwise.

All references to singular characteristics or limitations of the present disclosure shall include the corresponding plural characteristics or limitations, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

The various embodiments of the nutritional powders of the present disclosure may include trace amounts of any optional or selected essential ingredient or feature described herein, provided that the remaining formulation still contains all of the required ingredients or features as described herein. In this context, and unless otherwise specified, the term “trace amount” means that the selected formulation contains no more than 2 wt % of the optional ingredient, typically less than 1 wt %, and also includes zero percent, of such optional or selected essential ingredient, by weight of the infant formula.

The various embodiments of the nutritional powders of the present disclosure may also be substantially free of any optional ingredient or feature described herein, provided that the remaining formulation still contains all of the required ingredients or features as described herein. In this context, and unless otherwise specified, the term “substantially free” means that the selected nutritional powder contains less than a functional amount of the optional ingredient, typically less than about 1 wt %, including less than about 0.5 wt %, including less than about 0.1 wt %, and also including zero percent, of such optional ingredient, by weight of the nutritional powder.

1. A nutritional powder pod for use in a liquid product or beverage production machine comprising a pod containing a nutritional powder, wherein the nutritional powder comprises particles, wherein the nutritional powder has a vibrated bulk density from about 0.2 g/cc to about 1 g/cc and a powder porosity from about 5% to about 80%.

2. (canceled)

3. (canceled)

4. The nutritional powder pod of claim 1, wherein the nutritional powder particles have an average volume particle size from about 25 μm to about 1000 μm.

5. The nutritional powder pod of claim 1, wherein the nutritional powder particles have particle shapes selected from the group consisting of sphere, spheroid, cube, cuboid, plate, flake, rod, thread, and combinations thereof.

6. The nutritional powder pod of claim 5, wherein the particle shapes have an aspect ratio between about 0.1 and about 1.

7. The nutritional powder pod of claim 1, wherein the flowability index ratio of the nutritional powder is from about 1 to about 2.

8. The nutritional powder pod of claim 1, wherein at least a portion of the nutritional powder is a spray dried powder, an extruded powder, a dry blended powder, or combinations thereof.

9. (canceled)

10. The nutritional powder pod of claim 1, wherein at least a portion of the nutritional powder is an agglomerated powder.

11. (canceled)

12. The nutritional powder pod of claim 1, wherein the nutritional powder is an infant formula, a pediatric formula, or an adult formula.

13.-15. (canceled)

16. The nutritional powder pod of claim 1, wherein the nutritional powder further comprises at least one wetting agent.

17. The nutritional powder pod of claim 16, wherein the wetting agent is a surfactant, an emulsifier, or a combination thereof.

18. (canceled)

19. The nutritional powder pod of claim 1, wherein the nutritional powder has a reconstitution yield of at least about 75%.

20. The nutritional powder pod of claim 1, wherein the nutritional powder pod contains from about 2 g to about 150 g of the nutritional powder.

21. A method of making a nutritional powder pod for use in a liquid product or beverage production machine comprising a nutritional powder, comprising the steps of:
producing a mixture comprising one or more of a protein, a carbohydrate, a fat, a vitamin, and a mineral,
drying the mixture to form a nutritional powder,
packaging the nutritional powder into a pod,
wherein the nutritional powder comprises particles, wherein the nutritional powder has a vibrated bulk density from about 0.2 g/cc to about 1 g/cc and a powder porosity from about 5% to about 80%.

22. The method of claim 21, further comprising the step of introducing a gas into the mixture.

23. The method of claim 21, further comprising the step of milling the nutritional powder.

24. The method of claim 21, further comprising the step of agglomerating at least a portion of the nutritional powder.

25. (canceled)

26. (canceled)

27. The method of claim 21, wherein at least a portion of the nutritional powder is produced by an extrusion process.

28. A package containing a plurality of nutritional powder pods according to claim 1.

29. A kit comprising a beverage production machine and one or more nutritional powder pods according to claim 1.

30. A nutritional powder pod produced by the method of claim 21.
